(19) United States
(12) Patent Application Publication
(10) Pub. No.: US 2026/0205210 A1
(43) Pub. Date: Jul. 16, 2026

(54) MEASUREMENT RELAXATION AND MEASUREMENT ASSISTANCE FOR PASSIVE WIRELESS DEVICES

(71) Applicant: QUALCOMM Incorporated, San Diego, CA (US)

(72) Inventors: Ruiming ZHENG, Beijing (CN); Chao WEI, Beijing (CN); Mingxi YIN, Beijing (CN); Hao XU, Beijing (CN); Kangqi LIU, San Diego, CA (US)

(21) Appl. No.: 19/136,237

(22) PCT Filed: Jan. 26, 2023
(86) PCT No.: PCT/CN2023/073473

§ 371 Date: Jun. 5, 2025

(51) Int. Cl. H04B 17/318; H04L 5/00; H04W 8/22

(52) U.S. Cl. CPC H04B 17/318; H04L 5/0051; H04W 8/22

(57) ABSTRACT

Methods, systems, and devices for wireless communication are described. A passive (e.g., ambient Internet of Things (A-loT IoT)) wireless device may receive a continuous wave signal from a Device 275 radio frequency (RF) source that triggers the passive device to measure an RF signal. Based on an amount of energy stored at the passive device, a received power of the signal, or both, the passive device may perform the measurement and transmit a report to a reader, which may forward the report to the RF source. Alternatively, the passive device may transmit a backscattered signal to the reader indicating its inability to perform the measurement, or a request for measurement assistance. The reader may measure a signal strength of the backscattered signal and transmit a corresponding measurement report to the RF source. Accordingly, the RF source may adjust its transmit power or trigger the passive device to switch to a different RF source.

### CROSS REFERENCE

This application is a 371 National Stage of PCT Application No. PCT/CN 2023/073473, filed on Jan. 26, 2023, entitled “MEASUREMENT RELAXATION AND MEASUREMENT ASSISTANCE FOR PASSIVE WIRELESS DEVICES”, and assigned to the assignee hereof. The disclosure of the prior Application is considered part of and is incorporated by reference into this Patent Application.

### FIELD OF TECHNOLOGY

The present disclosure relates to wireless communication, including measurement relaxation and measurement assistance for passive wireless devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some UEs may perform measurements to perform cell selection or similar mobility procedures. In addition, passive or low-power wireless devices may perform such measurements to select radio frequency (RF) sources. However, passive wireless devices may store less energy than full-capability UEs, and as such may lack the energy to perform the measurements.

### SUMMARY

The described techniques relate to improved methods, systems, devices, and apparatuses that support measurement relaxation and measurement assistance for passive wireless devices. For example, the described techniques provide for measurement relaxation and assistance for ambient Internet-of-Things (A-IoT) devices. In some examples, an A-IoT device may receive a continuous wave signal from a radio frequency (RF) source that triggers the A-IoT device to perform a measurement of a signal, such as an RF resource management (RRM) measurement. The A-IoT device may perform the measurement based on some energy information, and the A-IoT device may transmit a measurement report to a reader that indicates the measurement. In some examples, the reader may forward the measurement report to the RF source such that the RF source may adjust its power based on the measurement. Alternatively, after receiving the continuous wave signal, the A-IoT device may transmit a backscattered signal to the reader via a backscattered link. The backscattered signal or some explicit indication (e.g., control signaling) may indicate an inability of the A-IoT wireless device to perform a measurement of a signal transmitted by the RF source. In such cases, the reader may perform a signal strength measurement of the backscattered signal and transmit a measurement report indicating the signal strength measurement to the RF source. Based on the measurement report, the RF source may adjust its power for the A-IoT device or the A-IoT device may be triggered to switch to a different RF source.

A method for wireless communication at a passive wireless device is described. The method may include receiving, from a first wireless device, a continuous wave signal, the continuous wave signal triggering the passive wireless device to perform a measurement of a signal transmitted by the first wireless device or by a second wireless device in a RF resource, performing, in response to receiving the continuous wave signal, the measurement of the signal in the RF resource based on an amount of energy stored by the passive wireless device satisfying an energy storage threshold, a received power level of the continuous wave signal satisfying a received power level threshold, or both, and transmitting, via a backscatter link, a report indicating the measurement of the signal in the RF resource.

An apparatus for wireless communication at a passive wireless device is described. The apparatus may include a processor, memory coupled with the processor, and instructions stored in the memory. The instructions may be executable by the processor to cause the apparatus to receive, from a first wireless device, a continuous wave signal, the continuous wave signal triggering the passive wireless device to perform a measurement of a signal transmitted by the first wireless device or by a second wireless device in a RF resource, perform, in response to receiving the continuous wave signal, the measurement of the signal in the RF resource based on an amount of energy stored by the passive wireless device satisfying an energy storage threshold, a received power level of the continuous wave signal satisfying a received power level threshold, or both, and transmit, via a backscatter link, a report indicating the measurement of the signal in the RF resource.

Another apparatus for wireless communication at a passive wireless device is described. The apparatus may include means for receiving, from a first wireless device, a continuous wave signal, the continuous wave signal triggering the passive wireless device to perform a measurement of a signal transmitted by the first wireless device or by a second wireless device in a RF resource, means for performing, in response to receiving the continuous wave signal, the measurement of the signal in the RF resource based on an amount of energy stored by the passive wireless device satisfying an energy storage threshold, a received power level of the continuous wave signal satisfying a received power level threshold, or both, and means for transmitting, via a backscatter link, a report indicating the measurement of the signal in the RF resource.

A non-transitory computer-readable medium storing code for wireless communication at a passive wireless device is described. The code may include instructions executable by a processor to receive, from a first wireless device, a continuous wave signal, the continuous wave signal triggering the passive wireless device to perform a measurement of a signal transmitted by the first wireless device or by a second wireless device in a RF resource, perform, in response to receiving the continuous wave signal, the measurement of the signal in the RF resource based on an amount of energy stored by the passive wireless device satisfying an energy storage threshold, a received power level of the continuous wave signal satisfying a received power level threshold, or both, and transmit, via a backscatter link, a report indicating the measurement of the signal in the RF resource.

Some examples of the method, apparatuses, and non-transitory computer-readable medium described herein may further include operations, features, means, or instructions for receiving, from the first wireless device or the second wireless device and via forward link, a control message triggering the passive wireless device to perform the measurement of the signal.

Some examples of the method, apparatuses, and non-transitory computer-readable medium described herein may further include operations, features, means, or instructions for transmitting a message indicating a preference of the passive wireless device to suspend the measurement of the signal based at least in the amount of energy stored by the passive wireless device and indicating a cause of suspending the measurement.

Some examples of the method, apparatuses, and non-transitory computer-readable medium described herein may further include operations, features, means, or instructions for skipping, in response to receiving the continuous wave signal, measurement of a second signal based at least in part the amount of energy stored by the passive wireless device failing to satisfy the energy storage threshold, the received power level of the continuous wave signal satisfying the received power level threshold, or both.

Some examples of the method, apparatuses, and non-transitory computer-readable medium described herein may further include operations, features, means, or instructions for detecting an increase in the amount of energy stored by the passive wireless device for a first time duration and performing the measurement of the signal in the RF resource for a second time duration based on detecting the increase.

Some examples of the method, apparatuses, and non-transitory computer-readable medium described herein may further include operations, features, means, or instructions for detecting a decrease in the amount of energy stored by the passive wireless device for a first time duration and suspending the measurement of the signal in the RF resource for a second time duration based on detecting the decrease.

Some examples of the method, apparatuses, and non-transitory computer-readable medium described herein may further include operations, features, means, or instructions for transmitting a capability message indicating a first capability of the passive wireless device to support detection of the amount of energy stored by the passive wireless device satisfying the energy storage threshold, the received power level of the continuous wave signal satisfying the received power level threshold, or both.

In some examples of the method, apparatuses, and non-transitory computer-readable medium described herein, performing the measurement of the signal may include operations, features, means, or instructions for performing a measurement of a set of multiple signals in the RF resource, where the set of multiple signals may be transmitted by a set of multiple RF source wireless devices including the first wireless device.

Some examples of the method, apparatuses, and non-transitory computer-readable medium described herein may further include operations, features, means, or instructions for receiving, from a network node, a control message indicating whether the passive wireless device may be to perform the measurement of the signal transmitted by the first wireless device or a different RF wireless device, where the measurement includes a one-shot measurement or a periodic measurement.

Some examples of the method, apparatuses, and non-transitory computer-readable medium described herein may further include operations, features, means, or instructions for receiving, via a forward link, a control message indicating one or more frequencies for which the passive wireless device may be to perform the measurement.

Some examples of the method, apparatuses, and non-transitory computer-readable medium described herein may further include operations, features, means, or instructions for selecting the first wireless device or a different RF wireless device that operates at a same frequency or a different frequency from the first wireless device as a source for continuous wave signal transmissions based on the report.

Some examples of the method, apparatuses, and non-transitory computer-readable medium described herein may further include operations, features, means, or instructions for transmitting, via the backscatter link, a backscattered signal indicating an inability of the passive wireless device to perform a RF resource measurement of the signal transmitted by the first wireless device.

Some examples of the method, apparatuses, and non-transitory computer-readable medium described herein may further include operations, features, means, or instructions for transmitting, via the backscatter link, a request for measurement assistance.

In some examples of the method, apparatuses, and non-transitory computer-readable medium described herein, performing the measurement of the signal may include operations, features, means, or instructions for performing the measurement of the signal in the RF resource based on a distance between the passive wireless device and the first wireless device being shorter than a distance threshold.

Some examples of the method, apparatuses, and non-transitory computer-readable medium described herein may further include operations, features, means, or instructions for receiving, from the first wireless device, a sensing reference signal in a sensing resource and performing a sensing measurement based on the sensing reference signal.

A method for wireless communication at a first wireless device is described. The method may include transmitting, to a passive wireless device, a continuous wave signal, the continuous wave signal triggering the passive wireless device to perform a measurement of a signal transmitted by the first wireless device or by a second wireless device in a RF resource, receiving a report indicating the measurement of the signal in the RF resource, and transmitting a second continuous wave signal at an increased power level or a control message indicating that the passive wireless device is to switch to a different RF wireless device as a source for continuous wave signal transmissions based on the report.

An apparatus for wireless communication at a first wireless device is described. The apparatus may include a processor, memory coupled with the processor, and instructions stored in the memory. The instructions may be executable by the processor to cause the apparatus to transmit, to a passive wireless device, a continuous wave signal, the continuous wave signal triggering the passive wireless device to perform a measurement of a signal transmitted by the first wireless device or by a second wireless device in a RF resource, receive a report indicating the measurement of the signal in the RF resource, and transmit a second continuous wave signal at an increased power level or a control message indicating that the passive wireless device is to switch to a different RF wireless device as a source for continuous wave signal transmissions based on the report.

Another apparatus for wireless communication at a first wireless device is described. The apparatus may include means for transmitting, to a passive wireless device, a continuous wave signal, the continuous wave signal triggering the passive wireless device to perform a measurement of a signal transmitted by the first wireless device or by a second wireless device in a RF resource, means for receiving a report indicating the measurement of the signal in the RF resource, and means for transmitting a second continuous wave signal at an increased power level or a control message indicating that the passive wireless device is to switch to a different RF wireless device as a source for continuous wave signal transmissions based on the report.

A non-transitory computer-readable medium storing code for wireless communication at a first wireless device is described. The code may include instructions executable by a processor to transmit, to a passive wireless device, a continuous wave signal, the continuous wave signal triggering the passive wireless device to perform a measurement of a signal transmitted by the first wireless device or by a second wireless device in a RF resource, receive a report indicating the measurement of the signal in the RF resource, and transmit a second continuous wave signal at an increased power level or a control message indicating that the passive wireless device is to switch to a different RF wireless device as a source for continuous wave signal transmissions based on the report.

Some examples of the method, apparatuses, and non-transitory computer-readable medium described herein may further include operations, features, means, or instructions for transmitting, to the second wireless device, a request for the second wireless device to transmit the control message indicating that the passive wireless device may be to switch to the different RF wireless device as the source for the continuous wave signal transmissions based on the report.

Some examples of the method, apparatuses, and non-transitory computer-readable medium described herein may further include operations, features, means, or instructions for transmitting, to the passive wireless device, a sensing reference signal in a sensing resource, where the first wireless device may be associated with a sensing capability.

A method for wireless communication at a second wireless device is described. The method may include receiving, via a backscatter link, a backscattered signal indicating an inability of a passive wireless device to perform a RF resource measurement of a signal transmitted by a first wireless device, performing a signal strength measurement of the backscattered signal, and transmitting, to the first wireless device, a report indicating the signal strength measurement of the backscattered signal.

An apparatus for wireless communication at a second wireless device is described. The apparatus may include a processor, memory coupled with the processor, and instructions stored in the memory. The instructions may be executable by the processor to cause the apparatus to receive, via a backscatter link, a backscattered signal indicating an inability of a passive wireless device to perform a RF resource measurement of a signal transmitted by a first wireless device, perform a signal strength measurement of the backscattered signal, and transmit, to the first wireless device, a report indicating the signal strength measurement of the backscattered signal.

Another apparatus for wireless communication at a second wireless device is described. The apparatus may include means for receiving, via a backscatter link, a backscattered signal indicating an inability of a passive wireless device to perform a RF resource measurement of a signal transmitted by a first wireless device, means for performing a signal strength measurement of the backscattered signal, and means for transmitting, to the first wireless device, a report indicating the signal strength measurement of the backscattered signal.

A non-transitory computer-readable medium storing code for wireless communication at a second wireless device is described. The code may include instructions executable by a processor to receive, via a backscatter link, a backscattered signal indicating an inability of a passive wireless device to perform a RF resource measurement of a signal transmitted by a first wireless device, perform a signal strength measurement of the backscattered signal, and transmit, to the first wireless device, a report indicating the signal strength measurement of the backscattered signal.

In some examples of the method, apparatuses, and non-transitory computer-readable medium described herein, the report indicates an identifier of the passive wireless device, a purpose for performing the signal strength measurement, or both.

Some examples of the method, apparatuses, and non-transitory computer-readable medium described herein may further include operations, features, means, or instructions for receiving, from a network node, a control message enabling the second wireless device to perform the signal strength measurement.

Some examples of the method, apparatuses, and non-transitory computer-readable medium described herein may further include operations, features, means, or instructions for detecting a sensing reference signal, where performing the signal strength measurement of the backscattered signal may be based on the sensing reference signal.

Some examples of the method, apparatuses, and non-transitory computer-readable medium described herein may further include operations, features, means, or instructions for receiving, via the backscatter link, a request for measurement assistance.

### BRIEF DESCRIPTION OF THE DRAWINGS

FIG. 1 illustrates an example of a wireless communications system that supports measurement relaxation and measurement assistance for passive wireless devices in accordance with one or more aspects of the present disclosure.

FIG. 2 illustrates an example of a wireless communications system that supports measurement relaxation and measurement assistance for passive wireless devices in accordance with one or more aspects of the present disclosure.

FIG. 3 illustrates examples of ambient Internet of Things (A-IoT) deployment scenarios that support measurement relaxation and measurement assistance for passive wireless devices in accordance with one or more aspects of the present disclosure.

FIG. 4 illustrates examples of A-IoT mobility scenarios that support measurement relaxation and measurement assistance for passive wireless devices in accordance with one or more aspects of the present disclosure.

FIGS. 5 and 6 illustrate examples of process flows that support measurement relaxation and measurement assistance for passive wireless devices in accordance with one or more aspects of the present disclosure.

FIGS. 7 and 8 illustrate block diagrams of devices that support measurement relaxation and measurement assistance for passive wireless devices in accordance with one or more aspects of the present disclosure.

FIG. 9 illustrates a block diagram of a communications manager that supports measurement relaxation and measurement assistance for passive wireless devices in accordance with one or more aspects of the present disclosure.

FIG. 10 illustrates a diagram of a system including a device that supports measurement relaxation and measurement assistance for passive wireless devices in accordance with one or more aspects of the present disclosure.

FIGS. 11 and 12 illustrate block diagrams of devices that support measurement relaxation and measurement assistance for passive wireless devices in accordance with one or more aspects of the present disclosure.

FIG. 13 illustrates a block diagram of a communications manager that supports measurement relaxation and measurement assistance for passive wireless devices in accordance with one or more aspects of the present disclosure.

FIG. 14 illustrates a diagram of a system including a device that supports measurement relaxation and measurement assistance for passive wireless devices in accordance with one or more aspects of the present disclosure.

FIGS. 15 through 18 illustrate flowcharts showing methods that support measurement relaxation and measurement assistance for passive wireless devices in accordance with one or more aspects of the present disclosure.

### DETAILED DESCRIPTION

Ambient Internet of Things (A-IoT) devices may include ultra-low complexity and ultra-low power passive wireless devices. In addition, A-IoT devices may lack radio frequency (RF) components, and may communicate with other wireless devices such as user equipments (UEs) and network entities via forward links and backscatter links to harvest energy. In some cases, an A-IoT device may be enabled to perform measurements (e.g., radio resource management (RRM) measurements) to select RF sources (also referred to herein as RF resources) for high-quality signal reception, and so that the A-IoT device may reflect and modulate RF signals back to a reader with sufficient power. However, A-IoT devices may lack sufficient energy (e.g., energy of a full-capability UE) to perform such measurements, and as such, the A-IOT devices may use relaxed measurement procedures based on energy-related criteria.

Techniques, systems, and devices described herein support measurement relaxation and assistance for A-IoT devices. In some examples, an A-IoT device (e.g., a passive wireless device) may receive a continuous wave signal from an RF source (e.g., a first wireless device) that triggers the A-IoT device to perform a measurement, such as an RRM measurement. The A-IoT device may perform the measurement if it currently has enough stored energy (e.g., above a threshold), if the A-IoT device receives the continuous wave signal at a low power level (e.g., below a threshold), or both. If the continuous wave signal is received at a high enough power level, the A-IoT device may skip or stop the measurement, thus utilizing measurement relaxation techniques. The A-IoT device may transmit a measurement report to a reader (e.g., a second wireless device), the report indicating the measurement. In some examples, the reader may forward the measurement report to the RF source such that the RF source may adjust its power according to the measurement.

Alternatively, after receiving the continuous wave signal from the RF source, the A-IoT device may transmit a backscattered signal to the reader via a backscatter link. The backscattered signal or an explicit indication (e.g., control signaling) may indicate an inability of the A-IoT wireless device to perform a measurement of a signal transmitted by the RF source. For example, if A-IT may be unable to perform the measurement if the A-IoT device lacks sufficient energy or if the continuous wave signal has too-low of a power. In such cases, the reader may perform a signal strength measurement of the backscattered signal and transmit a measurement report indicating the signal strength measurement to the RF source. Based on the measurement report, the RF source may adjust its power for the A-IoT device or the A-IoT device may be triggered to switch to a different RF source.

Aspects of the subject matter described herein may be implemented to realize one or more of the following potential improvements, among others. The techniques employed by the described wireless devices (e.g., A-IoT devices, RF sources, readers) may improve power efficiency of low-power devices as an A-IOT device may communicate its power requirements via an RRM measurement report or backscattered link. In addition, the described techniques may reduce power consumption by enabling measurement relaxation techniques for the A-IoT device. Moreover, the described techniques may reduce hardware, software, and firmware complexity of wireless devices by enabling reader-assisted A-IoT RRM measurements and A-IoT RRM measurements with sensing assistance.

Aspects of the disclosure are initially described in the context of wireless communications systems. Aspects of the disclosure are then described in the context of A-IoT deployment and mobility scenarios and process flows. Aspects of the disclosure are further illustrated by and described with reference to apparatus diagrams, system diagrams, and flowcharts that relate to measurement relaxation and measurement assistance for passive wireless devices.

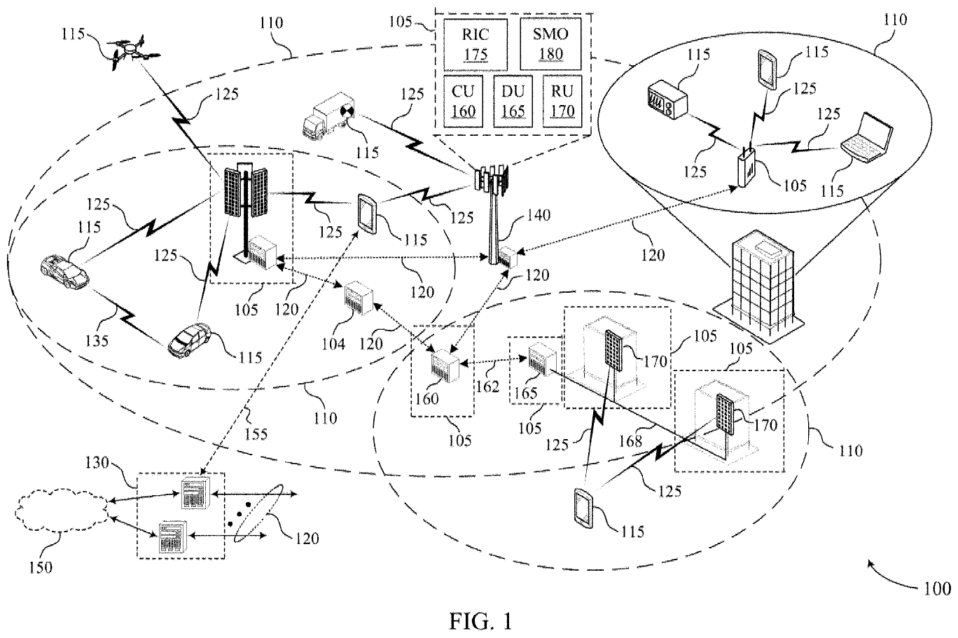

FIG. 1 illustrates an example of a wireless communications system 100 that supports measurement relaxation and measurement assistance for passive wireless devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network node, network element, a mobility element, a radio access network (RAN) node, or network equipment, among other nomenclature. In some examples, network entities 105 and UEs 115 may wirelessly communicate via one or more communication links 125 (e.g., an RF access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3 ), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support measurement relaxation and measurement assistance for passive wireless devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUS 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an IoT device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N₇₁) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N₇₁) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, a UE 115 in an RRC connected state may perform measurements (e.g., RRM) for connected mode mobility procedures. Some measurement types to be performed by the UE 115 in a connected state may include intra-frequency NR measurements, inter-frequency NR measurements, inter-RAT measurements for E-UTRA, and inter-RAT measurements for UTRA. For each measurement type, a network node 105 may define and configure one or several measurement objects (e.g., RF sources). In some examples, the UE 115 also may perform some measurement following a rule for cell selection or cell re-selection (e.g., NR intra-frequency and NR-inter frequency measurements) when in an RRC idle or inactive state.

A network node 105 may configure whether to enable measurement relaxation for a UE 115. In some cases, the measurement relaxation may be based on the network node 105 configuring particular parameters for the UE 115 (e.g., relaxedMeasurement, highPriorityMeasRelax), a location of the UE 115 (e.g., relative to a cell edge), mobility of the UE 115, or any combination thereof. The network node 105 may signal relaxation criteria for RRC connected, idle, or inactive states in system information or dedicated control signaling. In addition, the UE 115 may have a capability to support measurement relaxation techniques.

In some examples, the UE 115 or a reduced capability (e.g., low complexity, low power) wireless device may use measurement relaxation mechanisms to relax such measurements for connected mode mobility procedures. Reduced capability devices may include A-IoT devices, which may be ultra-low complexity and ultra-low power passive wireless devices that provide complexity and power consumption significantly lower than that of full-capability eMTC and NB-IOT devices. Some A-IoT devices (e.g., Type A devices) may lack batteries and as such, may lack energy storage capabilities. Some other A-IoT devices (e.g., Type B devices) may be devices with energy storage, up to an amount that is available from ambient sources via energy harvesting, and that may lack a requirement for being manually replaced or recharged.

As A-IoT devices may be passive wireless devices, they may lack active RF components. As such, an A-IoT device may receive energy used to operate from incoming RF signals and may modulate reflection coefficients of its antennas to backscatter an information signal to a reader. In some cases, the A-IoT device may perform a measurement in different RRC states (e.g., connected, idle, inactive, or state-less). The A-IoT device may perform such measurements to select an RF source that may provide high quality signal reception such that the A-IoT device may reflect and modulate RF signals to a reader with enough power. The measurements may be RRM measurements based on a measObject parameter while the A-IoT device is in an RRC connected state, or the measurements may be for cell selection or cell re-selection while the A-IoT device is in an RRC idle or inactive state. In some examples, A-IoT wireless devices may lack sufficient energy to perform the measurements (e.g., may lack enough energy to perform RRM measurements as a UE 115 may), and as such may benefit from relaxing the measurements based on power consumption criteria. For example, RF identification (RFID) devices may have a limited reading range (e.g., several meters) making it difficult to support a large-scale deployment with sufficient coverage. Accordingly, RFID device functionality may be improved with ambient power-enabled IoT techniques as described herein.

The wireless communications system 100 may support techniques for measurement relaxation and assistance for A-IoT devices. In some examples, an A-IoT device (e.g., a passive wireless device) may receive a continuous wave signal from an RF source (e.g., a first wireless device) that triggers the A-IoT device to perform a measurement, such as an RRM measurement, of a signal. The A-IoT device may perform the measurement based on some energy information, and the A-IoT device may transmit a measurement report to a reader (e.g., a second wireless device) that indicates the measurement. In some examples, the reader may forward the measurement report to the RF source such that the RF source may adjust its power based on the measurement. Alternatively, after receiving the continuous wave signal, the A-IoT device may transmit a backscattered signal to the reader via a backscattered link. The backscattered signal or an explicit indication (e.g., control signaling) may indicate an inability of the A-IoT wireless device to perform a measurement of a signal transmitted by the RF source. In such cases, the reader may perform a signal strength measurement of the backscattered signal and transmit a measurement report indicating the signal strength measurement to the RF source. Based on the measurement report, the RF source may adjust its power for the A-IoT device or the A-IoT device may be triggered to switch to a different RF source.

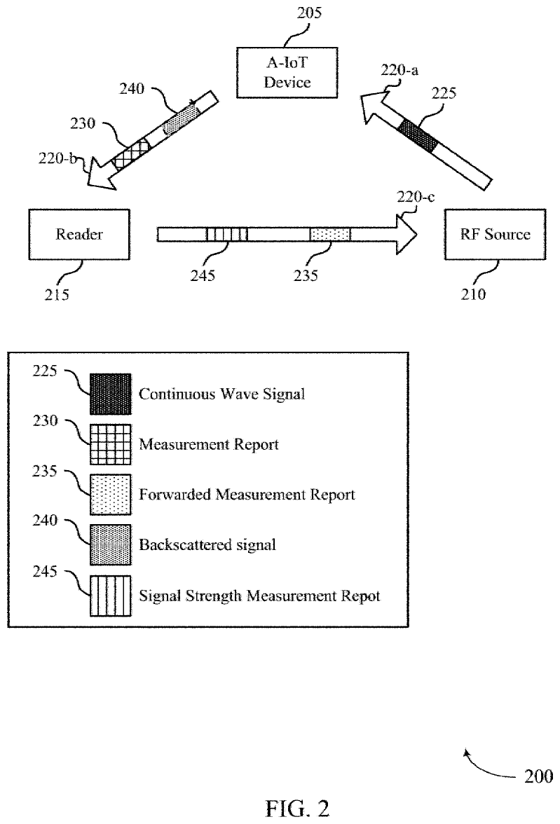

FIG. 2 illustrates an example of a wireless communications system 200 that supports measurement relaxation and measurement assistance for passive wireless devices in accordance with one or more aspects of the present disclosure. In some examples, the wireless communications system 200 may implement aspects of the wireless communications system 100 or may be implemented by aspects of the wireless communications system 100. For example, the wireless communications system 200 may include an A-IoT device 205 (e.g., a passive wireless device, an A-IoT UE), an RF source 210, and a reader 215. The RF source 210 and the reader 215 may assist the A-IoT device 205 with relaxing measurements, or may assist the A-IoT in performing measurements (e.g., RRM measurements) based on some power or energy criteria.

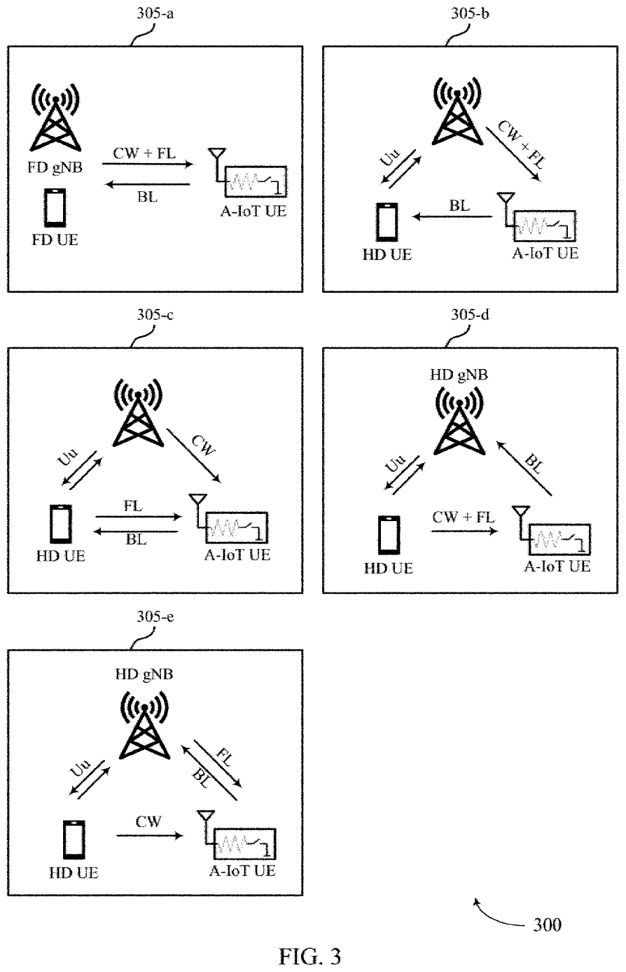

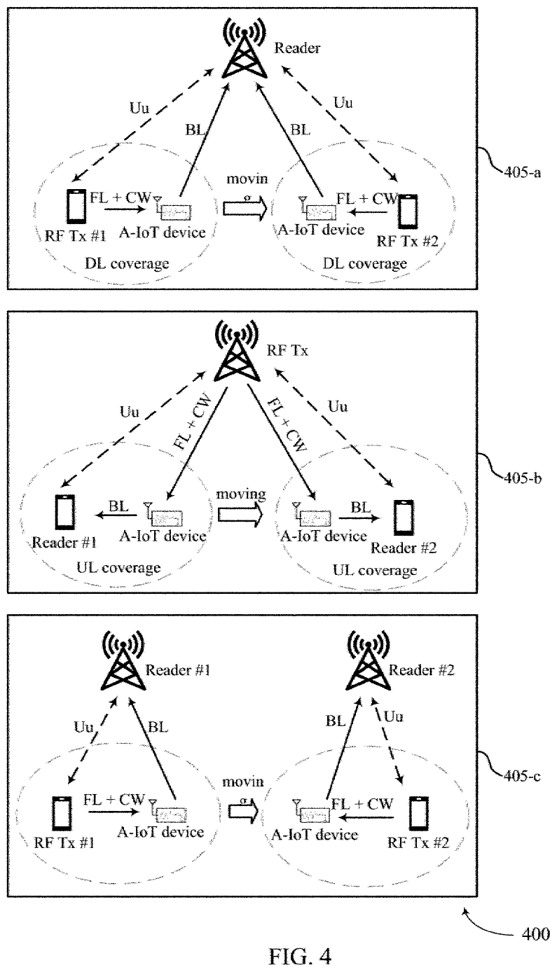

The wireless communications system 200 may support communications between the A-IoT device 205, the RF source 210 (e.g., an RF transmitter), and the reader 215. In some examples, the RF source 210 and the reader 215 may be devices such as UEs 115 and network entities 105, as described herein with reference to FIGS. 3 and 4. The A-IoT device 205, the RF source 210, and the reader 215 may communicate via communications links 220, which may be examples if communications links 125 described herein with reference to FIG. 1. For example, the A-IoT device 205 may communicate with the RF source 210 via a communications link 220-a, which may be an example of a forward link that carries control signaling. In addition, the A-IoT device 205 may communicate with the reader 215 via a communications link 220-b, which may be an example of a backscatter link that carries data. In some examples, the RF source 210 and the reader 215 may communicate via a communications link 220-c, which may be an example of a Uu link.

The A-IoT device 205 may receive, via the communications link 220-a (the forward link), a continuous wave signal 225 from the RF source 210. Receiving the continuous wave signal 225 from the RF source 210 may trigger the A-IoT device 205 to perform a measurement (e.g., an RRM measurement) of a signal (e.g., an RF signal) transmitted by the RF source 210 or the reader 215 in an RF resource and if particular conditions are satisfied (e.g., a level of received power or the status of energy of the A-IoT device 205). As such, the continuous wave signal 225 may implicitly trigger the A-IoT device 205 to perform the measurement. In addition, the A-IoT device 205 may acquire an RF resource identifier from the continuous wave signal.

Alternatively, the A-IoT device 205 may be triggered to perform the measurement based on an indication in explicit signaling (e.g., control signaling) via a forward link from either the RF source 210 or the reader 215. That is, the A-IoT device 205 may receive, from the RF source 210 or the reader 215, a control message triggering the A-IoT device 205 to perform the measurement of the signal.

The A-IoT device 205 may perform the measurement in response to receiving the continuous wave signal 225 and based on the conditions. For example, the A-IoT device 205 may perform the measurement if an amount of energy stored by the A-IoT device 205 satisfies (e.g., is above) an energy storage threshold, a received power level of the continuous wave signal 225 satisfies (e.g., is below) a received power level threshold, or both. The RRM measurement of the signal may measure different characteristics of the RF source 210, which may provide energy to the A-IoT device 205.

In some examples, the A-IoT device may indicate its preference for stopping (e.g., suspending, freezing) an RRM measurement to the RF source 210 or the reader 215. That is, the A-IoT device may transmit a message indicating its preference to suspend the measurement of an RF signal based on an amount of energy stored by the A-IoT device 205. For example, the A-IoT device 205 may prefer to stop the measurement if the A-IoT device 205 lacks sufficient energy to perform the measurement. In some examples, the message may be an example of assistance information including a multi-bit bitmap that indicates the preference to suspend the measurement and a cause of suspending the measurement. The cause may be indicated via a “measurement stop cause” indication using one or more bits. In addition, a different stop cause may lead to different behaviors. For example, if the “measurement stop cause” indicates a lack of energy at the A-IoT device 205, the RF source 210 may increase a signal power of the continuous wave signal 225. Based on an implementation in the wireless communications system 200, the A-IoT device 205 may determine whether or not to restart the measurement when enough energy becomes available.

As described herein the A-IoT device may perform the measurement based on considering an energy status (e.g., stored energy, increases and decreases in energy), a received signal strength of the continuous wave signal 225, or both. Based on the energy status, the A-IoT device 205 may relax or stop performing the measurement. For example, if the A-IoT device 205 receives a trigger for performing the measurement from the RF source 210 or the reader 215, and if the amount of energy stored at the A-IoT device 205 is large enough, if the received continuous wave signal 225 lacks sufficient power, or both, the A-IoT device 205 may perform a normal RRM measurement of an RF signal. Otherwise, the A-IoT device 205 may apply measurement relaxation techniques for power saving purposes.

In some examples, if the stored energy of the A-IoT device is above the energy storage threshold, the A-IoT device may be allowed to perform an RRM measurement in a corresponding SSB-based measurement timing configuration (SMTC). Otherwise, the A-IoT device 205 may skip the measurement as the A-IoT device 205 may lack the energy to perform the measurement. Alternatively, if a reference signal received power (RSRP) of the continuous wave signal 225 is above the received power level threshold (e.g., high enough), the A-IoT device 205 may skip measurement objects (e.g., RF sources) for a duration of time, T, or may evaluate criteria for measurement relaxation. In some examples, a network node 105 may configure the duration, T, in which the A-IoT device 205 may skip an SMTC, or the network node 105 may configure a smaller value of T_{seaechDeltaP} and S_{searchDeltaP} for RRM relaxation. Otherwise, the A-IoT device 205 may perform an RRM measurement as described herein, indicating that a current signal strength of the serving RF source 210 may fail to satisfy requirements of the A-IoT device 205. In this way, the A-IoT device 205 may skip, in response to receiving the continuous wave signal 225, measurement of a second signal (e.g., a second RF source signal) based on the amount of energy stored by the A-IoT device 205 failing to satisfy (e.g., being below) the energy storage threshold, the received power level of the continuous wave signal 225 failing to satisfy (e.g., being above) the received power level threshold, or both.

In some examples, the A-IoT device 205 may detect an increase or a decrease in its status of energy. For example, if the A-IoT device 205 detects an increase in energy S₁ during a time duration T₁, the A-IoT device 205 may perform the RRM measurement. Otherwise, the A-IoT device 205 may stop the measurement with a duration of T₂. That is, the A-IoT device 205 may detect an increase in the amount of energy stored by the A-IoT device 205 for a first time duration (e.g., T₁) and perform the measurement of the signal in the RF resource for a second time duration (e.g., T₂) based on detecting the increase. Alternatively, the A-IoT device 205 may detect a decrease in energy S₂ in a time duration T₃ and accordingly, may stop the measurement for a time duration T₄. That is, the A-IoT device 205 may detect a decrease in the amount of energy stored by the A-IoT device 205 for a first time duration (e.g., T₃) and suspend the measurement of the signal in the RF resource for a second time duration (e.g., T₄) based on detecting the decrease.

Whether the A-IoT device 205 supports performing a measurement based on an energy status or based on a signal strength of a received continuous wave signal 225 may be separate capabilities. In addition, the capabilities may be per A-IoT device 205 (or per UE 115) with a frequency range differentiation (e.g., per band, per band combination). The A-IoT device 205 may transmit a capability message indicating a first capability of the A-IoT device 205 to support detection of the amount of energy stored by the A-IoT device 205 satisfying (e.g., being above) the energy storage threshold, the received power level of the continuous wave signal 225 satisfying (e.g., being below) the received power level threshold, or both.

In some examples, the A-IoT device 205 may use a reduced list of neighbor RF sources for measuring RF signals. That is, the A-IoT device 205 may perform measurements of RF signals transmitted from a subset of a list of neighbor RF sources. For example, the A-IoT device 205 may perform a measurement of a set of multiple signals (e.g., continuous wave signals 225, RF signals) in the RF resource, where the set of multiple signals are transmitted by a set of multiple RF sources including the RF source 210. In some cases, the A-IoT device 205 may evaluate received continuous wave signals among the subset of the list of RF resources for RRM measurement.

In some cases, the list of RF sources may be configured in control signaling, such as, for example, in system information or via dedicated RRC signaling. Additionally, the reader 215, which may be a network node 105 or a UE 115, may configure or indicate which neighbor RF source the A-IoT device 205 may perform measurements for. In some cases, the network node 105 or the UE 115 may configure different values of A-IoT-specific SMTC windows and corresponding window periodicities. The A-IoT device 205 may perform one-shot or periodical measurements on the RF source indicated in the network configuration. In this way, the A-IoT device 205 may receive, from a network node 105 (which may be the reader 215), a control message indicating whether the A-IoT device 205 is to perform the measurement of the signal transmitted by the RF source 210 or by a different RF wireless device, where the measurement may include a one-shot measurement or a periodic measurement.

In some examples, the A-IoT device 205 may receive signaling via a forward link (e.g., the communications link 220-a) indicating at which frequencies the A-IoT device 205 is to measure RF signals. The RRM measurement in the frequency domain may be relaxed, where relaxed measurement techniques may include intra-frequency measurements, inter-frequency measurements, inter-RAT measurements, or any combination thereof, all of which may be configured by a network node 105 via control signaling.

Based on performing the measurement of one or more RF signals, the A-IoT device 205 may transmit to the reader 215 and via a backscatter link (e.g., the communications link 220-b), a measurement report 230 indicating the measurement of the signal in the RF resource. The reader 215 may transmit a forwarded measurement report 235 (e.g., forward the measurement report 230) to the RF source 210 via the communications link 220-c. Based on the measurement indicated in the forwarded measurement report 235, the RF source 210 may adjust its signal power to suit the requirements of the A-IoT device 205.

In some examples, the A-IoT device 205 may be incapable of measuring an RF signal (e.g., based on whether the A-IoT device 205 has a battery), and as such, the A-IoT device 205 may request that the reader 215 assist (e.g., help) the A-IoT device 205 in performing the measurement. In some cases, after receiving the continuous wave signal 225 from the RF source 210, the A-IoT device 205 may indicate its disability to perform RRM measurements of RF signals via one or more backscattered signals (e.g., backscattering the continuation wave signal from the RF source to the reader). The A-IoT device 205 may backscatter the continuation wave signal by modulating the continuation wave signal or performing other operation on the continuation wave signal. The A-IoT device 205 may transmit, via a backscatter link (e.g., the communications link 220-b), a backscattered signal 240 indicating an inability of the A-IoT device 205 to perform an RRM measurement of a signal transmitted by the RF source 210.

In response to receiving the backscattered signal 240, the reader 215 may perform a signal strength measurement of the backscattered signal 240. In this way, the A-IoT device 205 may reflect an RF signal received from the RF source 210 with a coefficient to the reader 215 to provide an implicit indication that the A-IoT device 205 is incapable of performing the RRM measurement at a current time. If the strength of the backscattered signal 240 is strong enough (e.g., satisfies a threshold), the reader 215 may determine that a power of RF signals transmitted by the RF source 210 is sufficient. Alternatively, the A-IoT device 205 may transmit an explicit request for measurement assistance to the reader 215 even if the A-IoT device 205 is capable of performing the RRM measurement itself. That is, in some cases, the A-IoT device 205 may transmit an explicit request for measurement assistance via the backscatter link. In this way, the reader 215 may determine to assist the A-IoT device 205 in performing the RRM measurement if the reader 215 receives an implicit indication or an explicit request for measurement assistance from the A-IoT device 205.

In such cases of reader-assisted A-IOT RRM measurement, the reader 215 may measure the signal strength of the backscattered signal. The strength of the measured backscattered signal may be relatively equivalent to the strength of continuous wave signal 225 received by A-IoT device 205 because the backscattered signal 240 is a reflection of the continuous wave signal 225. The signal strength measurement report 245 indicates the signal strength of backscattered signal 240, which may be different from the RRM measurement results from the A-IoT device 205 itself. Put another way, the RRM measurement by A-IoT device 205 is for the A-IoT device 205 to measure the RF source 210 in a given frequency band, which is different from the signal strength measurement of the backscattered signal. Both measurements may assist the A-IoT device 205 in utilizing a more suitable RF wireless device from which to harvest energy.

When the reader 215 completes the signal strength measurement of the backscattered signal 240, the reader 215 reports the measurement results to the RF source 210 in order to help the A-IoT device 205 select an improved RF source 210. That is, the reader 215 may transmit, to the RF source 210, a signal strength measurement report 245 indicating the signal strength measurement of the backscattered signal. In some examples, the signal strength measurement report 245 may include an identifier of the A-IoT device 205 in addition to the measurement results. Additionally, or alternatively, the signal strength measurement report 245 may indicate a purpose of the RRM measurement in addition to the measurement results. For example, the purpose may be to assist the A-IoT device 205. In some examples, whether the reader 215 may assist the A-IOT device 205 in the RRM measurement may be based on a network configuration. For example, the reader 215 may receive, from a network node 105, a control message enabling the reader 215 to perform the signal strength measurement of the backscattered signal 240, thus supporting the measurement assistance for the A-IoT device 205.

In response to receiving the signal strength measurement report 245 from the reader 215, the RF source 210 may perform one of several actions associated with measurement assistance for the A-IoT device 205. In some examples, the RF source 210 may increase a power (e.g., signal strength, RF power) of RF signals it transmits to the A-IoT device 205. For example, the RF source 210 may transmit a second continuous wave signal to the A-IoT device 205 at an increased power level based on the signal strength measurement report 245. Alternatively, the RF source 210 may assist the A-IoT device 205 in switching to another RF source. For example, the RF source 210 may transmit control signaling to the A-IoT device 205 indicating that the A-IoT device 205 is to switch to a different RF wireless device as a source for continuous wave transmissions based on the signal strength measurement report 245. Alternatively, the RF source 210 may transmit a request to the reader 215 to inform the A-IoT device 205 to switch to another RF source. That is, the RF source 210 may transmit, to the reader 215, a request for the reader 215 to transmit the control message indicating that the A-IoT device 205 is to switch to the different RF wireless device as the source for the continuous wave signal transmissions based on the signal strength measurement report 245. Accordingly, the A-IoT device 205 may select the RF source 210 or a different RF source (e.g., RF wireless device) that operates at a same frequency or a different frequency from the RF source 210 as the source for the continuous wave signal transmissions.

Whether the A-IoT device 205 may be required to perform an RRM measurement may be related to a signal strength received from the RF source 210 (e.g., a serving RF source), which may be impacted by a distance between the RF source 210 and the A-IoT device 205. As such, in performing the RRM measurement, the A-IoT device 205 may consider a sensing measurement, where a network node 105 may configure a sensing resource (for performing the sensing measurement) and the RF resource (for performing the RRM measurement) separately. If a criteria for a sensing result is unmet, the A-IoT device 205 may perform the RRM measurement. Otherwise, the A-IoT device 205 may relax or stop (e.g., suspend) the RRM measurement. For example, the A-IoT device 205 may refrain from performing intra-frequency measurements. The criteria may be defined as a distance between the A-IoT device 205 or the reader 215 and the RF source 210 being shorter than a distance threshold, where the distance threshold may be advertised by system information. In this way, the A-IoT device 205 may perform the measurement of the RF signal in the RF resource based on a distance between the A-IoT device 205 and the RF source 210 being shorter than a distance threshold.

In some cases, which wireless device measures sensing may depend on each wireless device's role in the RRM measurement. For example, the RF source 210 may transmit a sensing reference signal together with an RF signal (e.g., the continuous wave signal 225) via a forward link, and the A-IoT device 205 may measure the sensing reference signal from the RF source 210. That is, the A-IoT device 205 may receive a sensing reference signal in a sensing resource from the RF source 210, and the A-IoT device 205 may perform a sensing measurement based on the sensing reference signal. Alternatively, sensing assistance may be applied for the reader-assisted RRM measurement. For example, the reader 215 may detect the sensing reference signal and determine to assist the A-IoT device 205 for the RRM measurement based on the sensing measurement. That is, the reader 215 may detect the sensing reference signal, where performing the signal strength measurement of the backscattered signal may be based on the sensing reference signal. In some examples, the A-IoT device 205 and the RF source 210 may be enabled with a sensing capability to perform the sensing measurements as described herein.

FIG. 3 illustrates an example of A-IoT deployment scenarios 300 that support measurement relaxation and measurement assistance for passive wireless devices in accordance with one or more aspects of the present disclosure. In some examples, the A-IoT deployment scenarios 300 may be implemented by wireless communications systems 305, which each may include a UE 115, a network node 105 (e.g., a gNB), an A-IoT device, or a combination thereof. In some examples, the wireless communications systems 305 may support measurement relaxation and measurement assistance for A-IoT devices (e.g., A-IoT UEs) in static scenarios based on signals communicated between the UEs 115 and network entities 105 with the A-IoT devices, where the UEs 115 and the network entities 105 may serve as readers or RF sources (e.g., RF transmitters).

A wireless communications system 305-a may support a monostatic deployment scenario for A-IoT wireless devices, where a full-duplex network node 105 or UE 115 may serve as a reader and an RF source for an A-IoT device. The full-duplex network node 105 and the full-duplex UE 115 may be capable of transmitting or receiving uplink or downlink communications simultaneously.

The network node 105 or the UE 115 may communicate with the A-IoT wireless device via a forward link (FL) and a backscatter link (BL). A forward link may carry control signaling from the network node 105 or the UE 115 to the A-IoT device, and the backscattered link may carry data from the A-IoT device to the network node 105 or the UE 115. In some examples, the network node 105 or the UE 115 may transmit a continuous wave (CW) signal to the A-IoT device via the forward link. The continuous wave signal may be used as a carrier signal for backscatter communication, where the continuous wave signal may implicitly or explicitly indicate an RF source identifier. That is, the continuous wave signal may provide RF energy to the A-IoT device.

Wireless communications systems 305-b, 305-c, 305-d, and 305-e may support bi-static deployment scenarios for A-IoT wireless devices, where a half-duplex network node 105 or UE 115 may serve as a reader or an RF source for an A-IoT device in each wireless communications system 305. The half-duplex network node 105 and the half-duplex UE 115 may communicate uplink or downlink communications at any given time. The wireless communications systems 305-b, 305-c, 305-d, and 305-e may support a half-duplex network node 105 and a half-duplex UE 115 that communicate with each other via Uu links. In addition, the network entities 105 and the UEs 115 in the wireless communications systems 305-b, 305-c, 305-d, and 305-e may serve as either an RF source or a reader for the A-IoT device, and may communicate with an A-IoT device via a forward link, a backscatter link, or both.

In the wireless communications system 305-b, an A-IoT device may receive a continuous wave signal from a network node 105 via a forward link, and the A-IoT device may transmit a backscattered signal to a UE 115 via a backscatter link. In the wireless communications system 305-c, an A-IoT device may receive a continuous wave signal from a network node 105, and may also receive forward link transmissions from a UE 115. The A-IoT device may transmit a backscattered signal to the UE 115 via a backscatter link. As such, in the wireless communications systems 305-b and 305-c, the network entities 105 may serve as RF sources and the UEs 115 may serve as readers.

In the wireless communications system 305-d, an A-IoT device may receive a continuous wave signal from a UE 115 via a forward link, and the A-IoT device may transmit a backscattered signal to a network node 105 via a backscatter link. In the wireless communications system 305-e, an A-IoT device may receive a continuous wave signal from a UE 115 and may receive signals from a network node 105 via a forward link. The A-IoT device may transmit a backscattered signal to the network node 105 via a backscattered link. As such, in the wireless communications systems 305-d and 305-e, the network entities 105 may serve as readers and UEs 115 may serve as RF sources.

In some examples, in response to receiving a continuous wave signal from an RF source, an A-IoT device in a wireless communications system 305 may perform a measurement (e.g., an RRM measurement) of a signal transmitted by the RF source or a reader based on satisfying some energy criterion or criteria. For example, the A-IoT device may perform the measurement if the continuous wave signal is received with a low power level (e.g., below a power level threshold) or if the A-IoT has enough stored energy. In some examples, the A-IT may transmit a report of the measurement via the backscatter link. Alternatively, if the A-IoT device lacks an ability to perform the measurement, the A-IoT device may transmit an explicit or indication to the reader via the backscattered link to perform measurement assistance.

FIG. 4 illustrates an example of A-IoT mobility scenarios 400 that support measurement relaxation and measurement assistance for passive wireless devices in accordance with one or more aspects of the present disclosure. In some examples, the A-IoT mobility scenarios 400 may be implemented by wireless communications systems 405, which each may include a UE 115, a network node 105 (e.g., a gNB), an A-IoT device. In some examples, the wireless communications systems 405 may support measurement relaxation and measurement assistance for A-IoT devices (e.g., A-IoT UEs) in mobility scenarios based on signals communicated between the UEs 115 and network entities 105 with the A-IoT devices, where the UEs 115 and the network entities 105 may serve as readers or RF sources (e.g., RF transmitters).

In some cases, wireless communications systems 405-a, 405-b, and 405-c may include a network node 105 and multiple UEs 115 that communicate with each other via Uu links. In some cases, the network entities 105 may support two coverage areas (e.g., downlink or uplink coverage) such that an A-IoT device may switch between multiple UEs 115 within respective coverage areas. The entity of a reader or an RF source in the wireless communications systems 405 may be either a UE 115 or a network node 105 (e.g., a gNB), which may be paired for a forward link (FL) or a backscattered link (BL).

In the wireless communications system 405-a, UEs 115 serving as RF sources may transmit continuous wave (CW) signals to an A-IoT device via forward links, and the A-IoT device may transmit backscattered signals to a network node 105 via backscattered links, the network node 105 serving as a reader. That is, the A-IoT device may receive the continuous wave signal (e.g., an RF signal) from the UE 115 (the RF source) and reflect and modulate the continuous wave signal to the network node (the reader) or in some cases, another UE 115. In such cases, the A-IoT device may switch RF sources (e.g., switch from a first UE 115 in a first coverage area to a second UE 115 in a second coverage area), but may continue communicating with a same reader (e.g., the network node 105).

In the wireless communications system 405-b, a network node 105 serving as an RF source may transmit continuous wave signals (e.g., RF signals) to an A-IoT device via forward links, and the A-IoT device may transmit backscattered signals to a UEs 115 via backscattered links, the UEs 115 serving as readers. That is, the A-IoT device may receive a continuous wave signal from the network node 105 (the RF source) or in some cases, a UE 115, and reflect the continuous wave signal to another UE 115 (e.g., the reader). In such cases, the A-IoT device may switch readers (e.g., switch from a first UE 115 in a first coverage area to a second UE 115 in a second coverage area), but may continue receiving RF signals from a same RF source (e.g., the network node 105).

In the wireless communications system 405-c, a UE 115 serving as an RF source may transmit continuous wave signals (e.g., RF signals) to an A-IoT device via a forward link, and the A-IoT device may transmit backscattered signals to a network node 105 via a backscattered link, the network node 105 serving as a reader. In some examples, the A-IoT device may switch both RF sources and readers (e.g., switch from a first UE 115 and a first network node 105 in a first coverage area to a second UE 115 and a second network node 105 in a second coverage area).

In some examples, in response to receiving a continuous wave signal from an RF source, an A-IoT device in a wireless communications system 405 may perform a measurement (e.g., an RRM measurement) of a signal transmitted by the RF source or a reader based on satisfying some energy criteria. For example, the A-IoT device may perform the measurement if the continuous wave signal is received with a low power level (e.g., below a power level threshold) or if the A-IoT has enough stored energy (e.g., exceeding a threshold). In some examples, the A-IoT may transmit a report of the measurement via the backscatter link. Alternatively, if the A-IoT device lacks an ability to perform the measurement, the A-IoT device may transmit an explicit or indication to the reader via the backscattered link to perform measurement assistance.

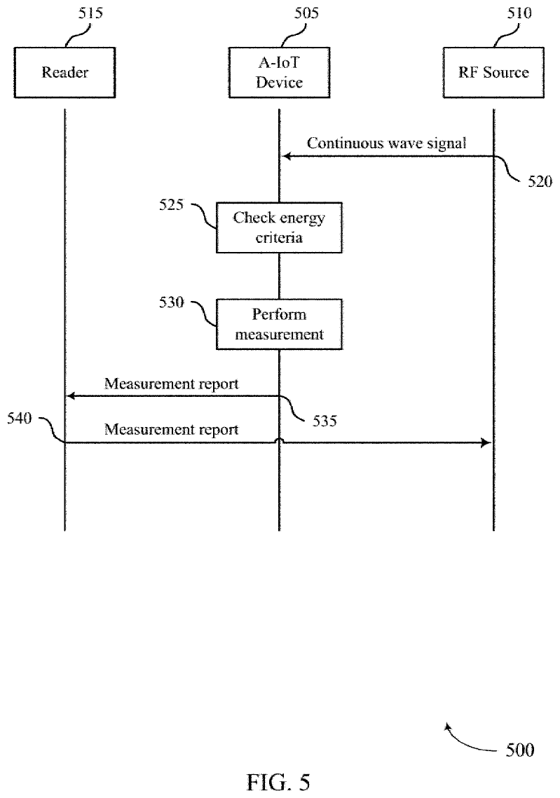

FIG. 5 illustrates an example of a process flow 500 that supports measurement relaxation and measurement assistance for passive wireless devices in accordance with one or more aspects of the present disclosure. The process flow 500 may implement aspects of wireless communications systems 100 and 200, or may be implemented by aspects of the wireless communications system 100 and 200. For example, the process flow 500 may illustrate operations between an A-IoT device 505 (e.g., a passive wireless device), an RF source 510 (e.g., a first wireless device), and a reader 515 (e.g., a second wireless device), which may be examples of corresponding devices described herein. In the following description of the process flow 500, the operations between the A-IoT device 505, the RF source 510, and the reader 515 may be transmitted in a different order than the example order shown, or the operations performed by the A-IoT device 505, the RF source 510, and the reader 515 may be performed in different orders or at different times. Some operations may also be omitted from the process flow 500, and other operations may be added to the process flow 500.

At 520, the A-IoT device 505 may receive, from the RF source 510 and via a forward link, a continuous wave signal. The continuous wave signal may be an RF signal transmitted with some power level. The continuous wave signal may trigger the A-IoT device 505 to perform a measurement (e.g., an RRM measurement) of a signal (e.g., an RF signal) transmitted by the RF source 510 or the reader 515 in an RF resource.

At 525, the A-IoT device 505 may check energy criteria to determine whether to perform the measurement. For example, the A-IoT device 505 may check energy status information such as an amount of energy stored at the A-IoT device 505 and a received power level associated with the continuous wave signal.

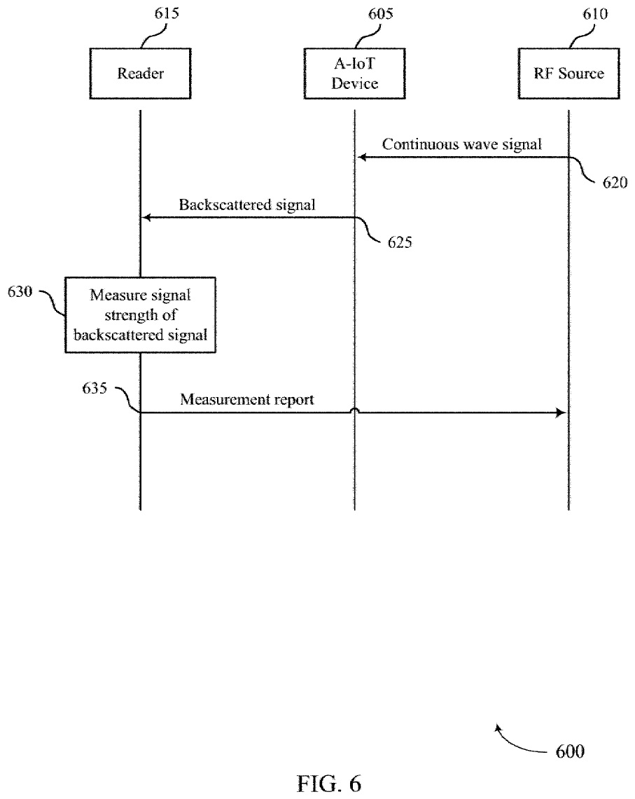

At 530, the A-IoT device 505 may perform, in response to receiving the continuous wave signal, the measurement of the signal in the RF resource based on an amount of energy stored by the A-IoT device 505 satisfying (e.g., being above) an energy storage threshold, a received power level of the continuous wave signal satisfying (e.g., being below) a received power level threshold, or both. If neither of these criteria are satisfied, the A-IoT device 505 may request measurement assistance as described with reference to FIG. 6 because of an inability of the A-IoT device 505 itself, or for other reasons based on an implementation of the A-IoT device 505 such as a lack of energy or the received power level being below the threshold.

At 535, the A-IoT device 505 may transmit, to the reader 515 and via a backscatter link, a report indicating the measurement of the signal in the RF measurement. At 540, the reader 515 may transmit (e.g., forward) the measurement report to the RF source 510. Based on the measurement report, the RF source 510 may determine whether to adjust its transmit power levels to better accommodate the A-IoT device 505.

FIG. 6 illustrates an example of a process flow 600 that supports measurement relaxation and measurement assistance for passive wireless devices in accordance with one or more aspects of the present disclosure. The process flow 600 may implement aspects of wireless communications systems 100 and 200, or may be implemented by aspects of the wireless communications system 100 and 200. For example, the process flow 600 may illustrate operations between an A-IoT device 605 (e.g., a passive wireless device), an RF source 610 (e.g., a first wireless device), and a reader 615 (e.g., a second wireless device), which may be examples of corresponding devices described herein. In the following description of the process flow 600, the operations between the A-IoT device 605, the RF source 610, and the reader 615 may be transmitted in a different order than the example order shown, or the operations performed by the A-IoT device 605, the RF source 610, and the reader 615 may be performed in different orders or at different times. Some operations may also be omitted from the process flow 600, and other operations may be added to the process flow 600.

At 620, the A-IoT device 605 may receive, from the RF source 610 and via a forward link, a continuous wave signal triggering the A-IoT device 605 to perform a measurement (e.g., an RRM measurement) of a signal (e.g., an RF signal) transmitted by the RF source 610 in an RF resource.

At 625, the reader 615 may receive, from the A-IoT device 605 and via a backscatter link, a backscattered signal indicating an inability of the A-IoT device 605 to perform the measurement of the signal transmitted by the RF source 610. In some examples, the inability may be based on the A-IoT device 605 lacking enough stored energy or the RF source 610 transmitting the continuous wave signal with a relatively low power (that fails to satisfy a threshold). In other cases, the inability may be based on an implementation of the A-IoT device 605 resulting in the A-IoT device 605 refraining from performing the measurement. Additionally, or alternatively, the reader 615 may receive, from the A-IoT device 605, an explicit request for measurement assistance, even if the A-IoT device 605 is capable of performing the measurement.

At 630, the reader 615 may perform a signal strength measurement of the backscattered signal. In some cases, the reader 615 may measure the signal strength of the backscattered signal based on the A-IoT device 605 reflecting the received continuous wave signal to the reader 615 with a coefficient. The measurement may indicate whether the A-IoT device 605 has sufficient power from the RF source 610.

At 635, the reader 615 may transmit, to the RF source 610, a measurement report indicating the signal strength measurement of the backscattered signal. Based on the measurement report, the RF source 610 may perform some action. For example, the RF source 610 may increase an RF power of its continuous wave signal transmissions. Alternatively, the RF source 610 may transmit control signaling indicating that the A-IoT device 605 is to switch from the RF source 610 to a different RF wireless device as a source of the continuous wave signal transmissions. Alternatively, the RF source 610 may transmit an indication to the reader 615 indicating that the reader 615 is to signal to the A-IoT device 605 to switch to the different RF wireless device.

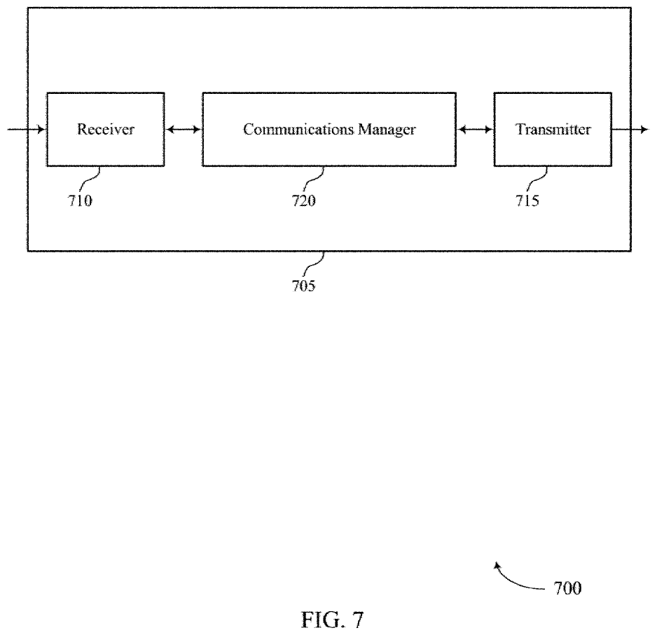

FIG. 7 illustrates a block diagram 700 of a device 705 that supports measurement relaxation and measurement assistance for passive wireless devices in accordance with one or more aspects of the present disclosure. The device 705 may be an example of aspects of a passive wireless device as described herein. The device 705 may include a receiver 710, a transmitter 715, and a communications manager 720. The device 705 may also include one or more processors, memory coupled with the one or more processors, and instructions stored in the memory that are executable by the one or more processors to enable the one or more processors to perform the measurement reporting and assistance features discussed herein. Each of these components may be in communication with one another (e.g., via one or more buses).

The receiver 710 may provide a means for receiving information such as packets, user data, control information, or any combination thereof associated with various information channels (e.g., control channels, data channels, information channels related to measurement relaxation and measurement assistance for passive wireless devices). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to measurement relaxation and measurement assistance for passive wireless devices). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of measurement relaxation and measurement assistance for passive wireless devices as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a passive wireless device in accordance with examples as disclosed herein. For example, the communications manager 720 may be configured as or otherwise support a means for receiving, from a first wireless device, a continuous wave signal, the continuous wave signal triggering the passive wireless device to perform a measurement of a signal transmitted by the first wireless device or by a second wireless device in a RF resource. The communications manager 720 may be configured as or otherwise support a means for performing, in response to receiving the continuous wave signal, the measurement of the signal in the RF resource based on an amount of energy stored by the passive wireless device satisfying an energy storage threshold, a received power level of the continuous wave signal satisfying a received power level threshold, or both. The communications manager 720 may be configured as or otherwise support a means for transmitting, via a backscatter link, a report indicating the measurement of the signal in the RF resource.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for measurement assistance and relaxation for passive wireless devices, which may reduce power consumption and reduce hardware, software, and firmware complexities.

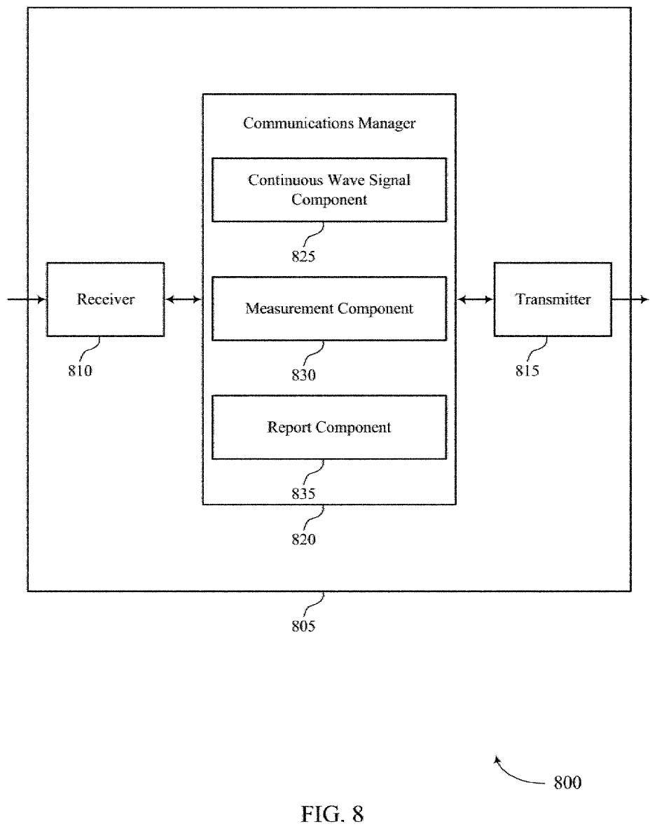

FIG. 8 illustrates a block diagram 800 of a device 805 that supports measurement relaxation and measurement assistance for passive wireless devices in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to measurement relaxation and measurement assistance for passive wireless devices). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to measurement relaxation and measurement assistance for passive wireless devices). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of measurement relaxation and measurement assistance for passive wireless devices as described herein. For example, the communications manager 820 may include a continuous wave signal component 825, a measurement component 830, a report component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a passive wireless device in accordance with examples as disclosed herein. The continuous wave signal component 825 may be configured as or otherwise support a means for receiving, from a first wireless device, a continuous wave signal, the continuous wave signal triggering the passive wireless device to perform a measurement of a signal transmitted by the first wireless device or by a second wireless device in a RF resource. The measurement component 830 may be configured as or otherwise support a means for performing, in response to receiving the continuous wave signal, the measurement of the signal in the RF resource based on an amount of energy stored by the passive wireless device satisfying an energy storage threshold, a received power level of the continuous wave signal satisfying a received power level threshold, or both. The report component 835 may be configured as or otherwise support a means for transmitting, via a backscatter link, a report indicating the measurement of the signal in the RF resource.

In some cases, the continuous wave signal component 825, the measurement component 830, and the report component 835 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the continuous wave signal component 825, the measurement component 830, and the report component 835 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

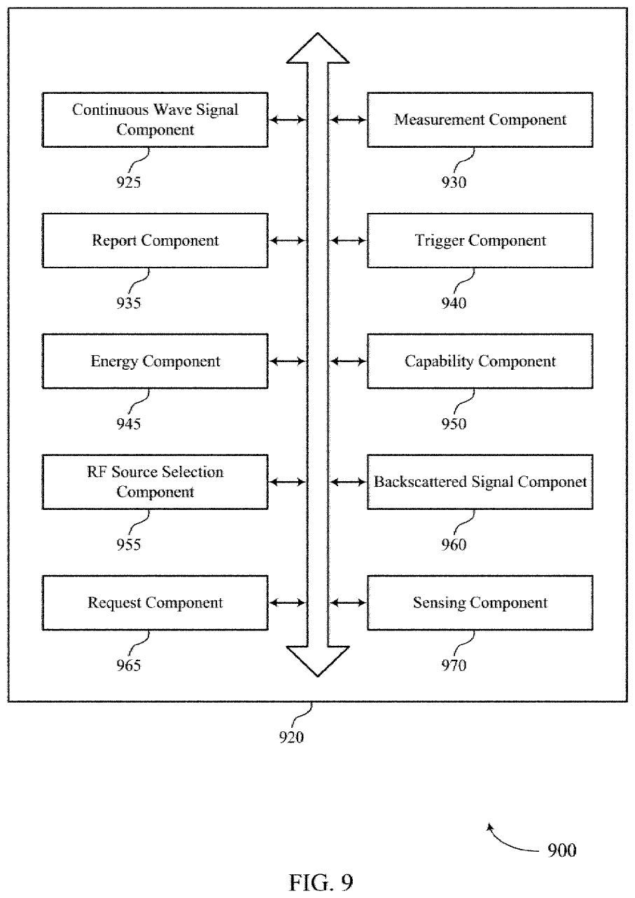

FIG. 9 illustrates a block diagram 900 of a communications manager 920 that supports measurement relaxation and measurement assistance for passive wireless devices in accordance with one or more aspects of the present disclosure. The communications manager 920 may be an example of aspects of a communications manager 720, a communications manager 820, or both, as described herein. The communications manager 920, or various components thereof, may be an example of means for performing various aspects of measurement relaxation and measurement assistance for passive wireless devices as described herein. For example, the communications manager 920 may include a continuous wave signal component 925, a measurement component 930, a report component 935, a trigger component 940, an energy component 945, a capability component 950, an RF source selection component 955, a backscattered signal component 960, a request component 965, a sensing component 970, or any combination thereof. Each of these components may communicate, directly or indirectly, with one another (e.g., via one or more buses).

The communications manager 920 may support wireless communication at a passive wireless device in accordance with examples as disclosed herein. The continuous wave signal component 925 may be configured as or otherwise support a means for receiving, from a first wireless device, a continuous wave signal, the continuous wave signal triggering the passive wireless device to perform a measurement of a signal transmitted by the first wireless device or by a second wireless device in a RF resource. The measurement component 930 may be configured as or otherwise support a means for performing, in response to receiving the continuous wave signal, the measurement of the signal in the RF resource based on an amount of energy stored by the passive wireless device satisfying an energy storage threshold, a received power level of the continuous wave signal satisfying a received power level threshold, or both. The report component 935 may be configured as or otherwise support a means for transmitting, via a backscatter link, a report indicating the measurement of the signal in the RF resource.

In some examples, the trigger component 940 may be configured as or otherwise support a means for receiving, from the first wireless device or the second wireless device and via forward link, a control message triggering the passive wireless device to perform the measurement of the signal.

In some examples, the measurement component 930 may be configured as or otherwise support a means for transmitting a message indicating a preference of the passive wireless device to suspend the measurement of the signal based at least in the amount of energy stored by the passive wireless device and indicating a cause of suspending the measurement.

In some examples, the measurement component 930 may be configured as or otherwise support a means for skipping, in response to receiving the continuous wave signal, measurement of a second signal based at least in part on the amount of energy stored by the passive wireless device failing to satisfy the energy storage threshold, the received power level of the continuous wave signal satisfying the received power level threshold, or both.

In some examples, the energy component 945 may be configured as or otherwise support a means for detecting an increase in the amount of energy stored by the passive wireless device for a first time duration. In some examples, the measurement component 930 may be configured as or otherwise support a means for performing the measurement of the signal in the RF resource for a second time duration based on detecting the increase.

In some examples, the energy component 945 may be configured as or otherwise support a means for detecting a decrease in the amount of energy stored by the passive wireless device for a first time duration. In some examples, the measurement component 930 may be configured as or otherwise support a means for suspending the measurement of the signal in the RF resource for a second time duration based on detecting the decrease.

In some examples, the capability component 950 may be configured as or otherwise support a means for transmitting a capability message indicating a first capability of the passive wireless device to support detection of the amount of energy stored by the passive wireless device satisfying the energy storage threshold, the received power level of the continuous wave signal satisfying the received power level threshold, or both.

In some examples, to support performing the measurement of the signal, the measurement component 930 may be configured as or otherwise support a means for performing a measurement of a set of multiple signals in the RF resource, where the set of multiple signals are transmitted by a set of multiple RF source wireless devices including the first wireless device.

In some examples, the measurement component 930 may be configured as or otherwise support a means for receiving, from a network node, a control message indicating whether the passive wireless device is to perform the measurement of the signal transmitted by the first wireless device or a different RF wireless device, where the measurement includes a one-shot measurement or a periodic measurement.

In some examples, the measurement component 930 may be configured as or otherwise support a means for receiving, via a forward link, a control message indicating one or more frequencies for which the passive wireless device is to perform the measurement.

In some examples, the RF source selection component 955 may be configured as or otherwise support a means for selecting the first wireless device or a different RF wireless device that operates at a same frequency or a different frequency from the first wireless device as a source for continuous wave signal transmissions based on the report.

In some examples, the backscattered signal component 960 may be configured as or otherwise support a means for transmitting, via the backscatter link, a backscattered signal indicating an inability of the passive wireless device to perform a RF resource measurement of the signal transmitted by the first wireless device.

In some examples, the request component 965 may be configured as or otherwise support a means for transmitting, via the backscatter link, a request for measurement assistance.

In some examples, to support performing the measurement of the signal, the measurement component 930 may be configured as or otherwise support a means for performing the measurement of the signal in the RF resource based on a distance between the passive wireless device and the first wireless device being shorter than a distance threshold.

In some examples, the sensing component 970 may be configured as or otherwise support a means for receiving, from the first wireless device, a sensing reference signal in a sensing resource. In some examples, the sensing component 970 may be configured as or otherwise support a means for performing a sensing measurement based on the sensing reference signal.

In some cases, the continuous wave signal component 925, the measurement component 930, the report component 935 the trigger component 940, the energy component 945, the capability component 950, the RF source selection component 955, the backscattered signal component 960, the request component 965, and the sensing component 970 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the continuous wave signal component 925, the measurement component 930, the report component 935 the trigger component 940, the energy component 945, the capability component 950, the RF source selection component 955, the backscattered signal component 960, the request component 965, and the sensing component 970 discussed herein.

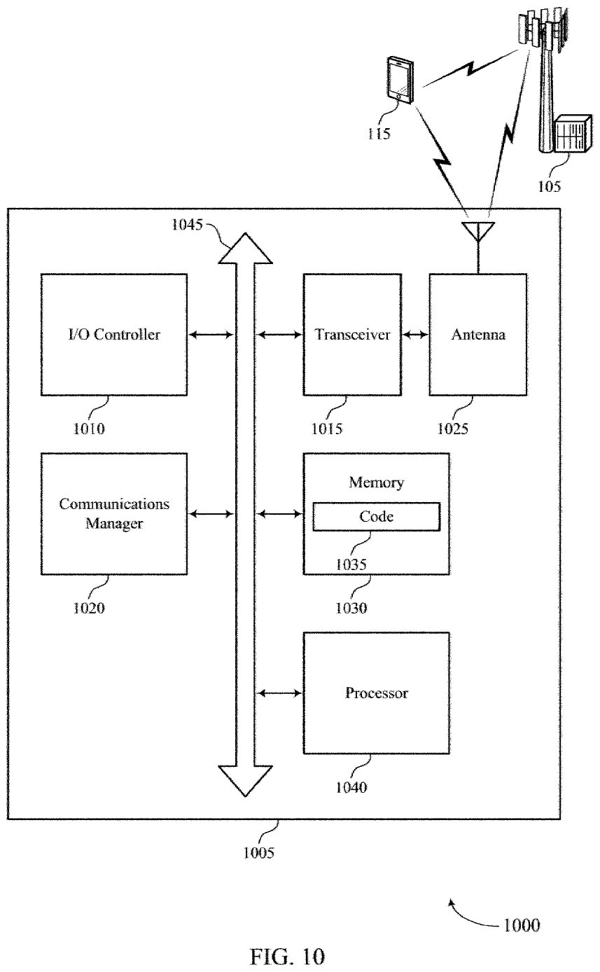

FIG. 10 illustrates a diagram of a system 1000 including a device 1005 that supports measurement relaxation and measurement assistance for passive wireless devices in accordance with one or more aspects of the present disclosure. The device 1005 may be an example of or include the components of a device 705, a device 805, or a passive wireless device as described herein. The device 1005 may include components for bi-directional voice and data communications including components for transmitting and receiving communications, such as a communications manager 1020, an I/O controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®), or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include RAM and ROM. The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a BIOS which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting measurement relaxation and measurement assistance for passive wireless devices). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a passive wireless device in accordance with examples as disclosed herein. For example, the communications manager 1020 may be configured as or otherwise support a means for receiving, from a first wireless device, a continuous wave signal, the continuous wave signal triggering the passive wireless device to perform a measurement of a signal transmitted by the first wireless device or by a second wireless device in a RF resource. The communications manager 1020 may be configured as or otherwise support a means for performing, in response to receiving the continuous wave signal, the measurement of the signal in the RF resource based on an amount of energy stored by the passive wireless device satisfying an energy storage threshold, a received power level of the continuous wave signal satisfying a received power level threshold, or both. The communications manager 1020 may be configured as or otherwise support a means for transmitting, via a backscatter link, a report indicating the measurement of the signal in the RF resource.

By including or configuring the communications manager 1020 in accordance with examples as described herein, the device 1005 may support techniques for measurement reporting and assistance for passive wireless devices, which may reduce power consumption and reduce hardware, software, and firmware complexities.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of measurement relaxation and measurement assistance for passive wireless devices as described herein, or the processor 1040 and the memory 1030 may be otherwise configured to perform or support such operations.

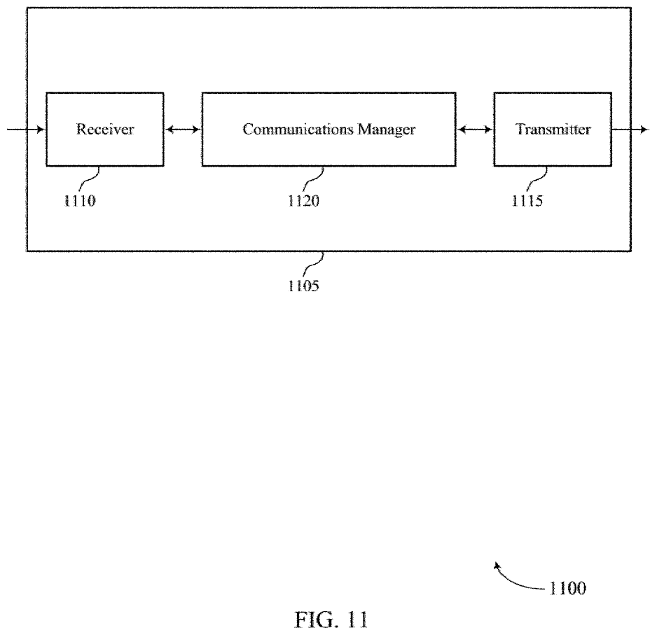

FIG. 11 illustrates a block diagram 1100 of a device 1105 that supports measurement relaxation and measurement assistance for passive wireless devices in accordance with one or more aspects of the present disclosure. The device 1105 may be an example of aspects of a wireless device as described herein. The device 1105 may include a receiver 1110, a transmitter 1115, and a communications manager 1120. The device 1105 may also include a one or more processors, memory coupled with the one or more processors, and instructions stored in the memory that are executable by the one or more processors to enable the one or more processors to perform the measurement reporting and assistance features discussed herein. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of measurement relaxation and measurement assistance for passive wireless devices as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a first wireless device in accordance with examples as disclosed herein. For example, the communications manager 1120 may be configured as or otherwise support a means for transmitting, to a passive wireless device, a continuous wave signal, the continuous wave signal triggering the passive wireless device to perform a measurement of a signal transmitted by the first wireless device or by a second wireless device in a RF resource. The communications manager 1120 may be configured as or otherwise support a means for receiving a report indicating the measurement of the signal in the RF resource. The communications manager 1120 may be configured as or otherwise support a means for transmitting a second continuous wave signal at an increased power level or a control message indicating that the passive wireless device is to switch to a different RF wireless device as a source for continuous wave signal transmissions based on the report.

Additionally, or alternatively, the communications manager 1120 may support wireless communication at a second wireless device in accordance with examples as disclosed herein. For example, the communications manager 1120 may be configured as or otherwise support a means for receiving, via a backscatter link, a backscattered signal indicating an inability of a passive wireless device to perform a RF resource measurement of a signal transmitted by a first wireless device. The communications manager 1120 may be configured as or otherwise support a means for performing a signal strength measurement of the backscattered signal. The communications manager 1120 may be configured as or otherwise support a means for transmitting, to the first wireless device, a report indicating the signal strength measurement of the backscattered signal.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for measurement reporting and assistance for passive wireless devices, which may reduce power consumption and reduce hardware, software, and firmware complexities.

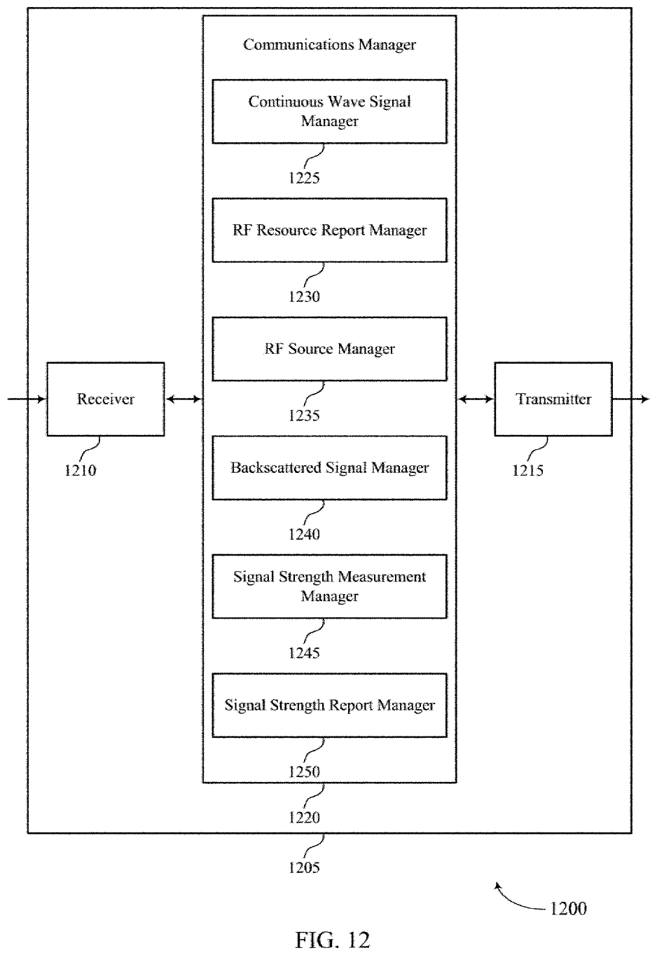

FIG. 12 illustrates a block diagram 1200 of a device 1205 that supports measurement relaxation and measurement assistance for passive wireless devices in accordance with one or more aspects of the present disclosure. The device 1205 may be an example of aspects of a device 1105 or a wireless device 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of measurement relaxation and measurement assistance for passive wireless devices as described herein. For example, the communications manager 1220 may include a continuous wave signal manager 1225, an RF resource report manager 1230, an RF source manager 1235, a backscattered signal manager 1240, a signal strength measurement manager 1245, a signal strength report manager 1250, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a first wireless device in accordance with examples as disclosed herein. The continuous wave signal manager 1225 may be configured as or otherwise support a means for transmitting, to a passive wireless device, a continuous wave signal, the continuous wave signal triggering the passive wireless device to perform a measurement of a signal transmitted by the first wireless device or by a second wireless device in a RF resource. The RF resource report manager 1230 may be configured as or otherwise support a means for receiving a report indicating the measurement of the signal in the RF resource. The RF source manager 1235 may be configured as or otherwise support a means for transmitting a second continuous wave signal at an increased power level or a control message indicating that the passive wireless device is to switch to a different RF wireless device as a source for continuous wave signal transmissions based on the report.

Additionally, or alternatively, the communications manager 1220 may support wireless communication at a second wireless device in accordance with examples as disclosed herein. The backscattered signal manager 1240 may be configured as or otherwise support a means for receiving, via a backscatter link, a backscattered signal indicating an inability of a passive wireless device to perform a RF resource measurement of a signal transmitted by a first wireless device. The signal strength measurement manager 1245 may be configured as or otherwise support a means for performing a signal strength measurement of the backscattered signal. The signal strength report manager 1250 may be configured as or otherwise support a means for transmitting, to the first wireless device, a report indicating the signal strength measurement of the backscattered signal.

In some cases, the continuous wave signal manager 1225, the RF resource report manager 1230, the RF source manager 1235, the backscattered signal manager 1240, the signal strength measurement manager 1245, and the signal strength report manager 1250 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the continuous wave signal manager 1225, the RF resource report manager 1230, the RF source manager 1235, the backscattered signal manager 1240, the signal strength measurement manager 1245, and the signal strength report manager 1250 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

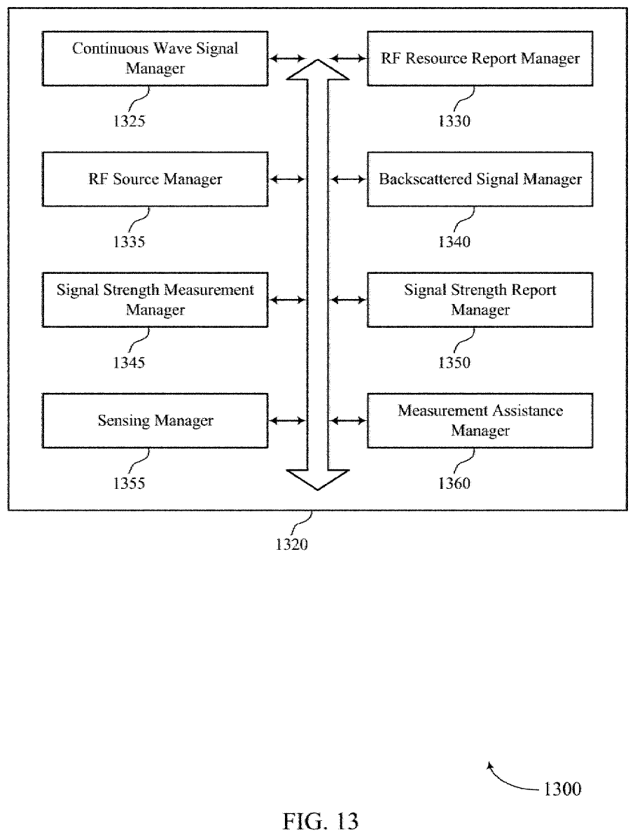

FIG. 13 illustrates a block diagram 1300 of a communications manager 1320 that supports measurement relaxation and measurement assistance for passive wireless devices in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of measurement relaxation and measurement assistance for passive wireless devices as described herein. For example, the communications manager 1320 may include a continuous wave signal manager 1325, an RF resource report manager 1330, an RF source manager 1335, a backscattered signal manager 1340, a signal strength measurement manager 1345, a signal strength report manager 1350, a sensing manager 1355, a measurement assistance manager 1360, or any combination thereof. Each of these components may communicate, directly or indirectly, with one another (e.g., via one or more buses).

The communications manager 1320 may support wireless communication at a first wireless device in accordance with examples as disclosed herein. The continuous wave signal manager 1325 may be configured as or otherwise support a means for transmitting, to a passive wireless device, a continuous wave signal, the continuous wave signal triggering the passive wireless device to perform a measurement of a signal transmitted by the first wireless device or by a second wireless device in a RF resource. The RF resource report manager 1330 may be configured as or otherwise support a means for receiving a report indicating the measurement of the signal in the RF resource. The RF source manager 1335 may be configured as or otherwise support a means for transmitting a second continuous wave signal at an increased power level or a control message indicating that the passive wireless device is to switch to a different RF wireless device as a source for continuous wave signal transmissions based on the report.

In some examples, the RF source manager 1335 may be configured as or otherwise support a means for transmitting, to the second wireless device, a request for the second wireless device to transmit the control message indicating that the passive wireless device is to switch to the different RF wireless device as the source for the continuous wave signal transmissions based on the report.

In some examples, the sensing manager 1355 may be configured as or otherwise support a means for transmitting, to the passive wireless device, a sensing reference signal in a sensing resource, where the first wireless device is associated with a sensing capability.

Additionally, or alternatively, the communications manager 1320 may support wireless communication at a second wireless device in accordance with examples as disclosed herein. The backscattered signal manager 1340 may be configured as or otherwise support a means for receiving, via a backscatter link, a backscattered signal indicating an inability of a passive wireless device to perform a RF resource measurement of a signal transmitted by a first wireless device. The signal strength measurement manager 1345 may be configured as or otherwise support a means for performing a signal strength measurement of the backscattered signal. The signal strength report manager 1350 may be configured as or otherwise support a means for transmitting, to the first wireless device, a report indicating the signal strength measurement of the backscattered signal. In some examples, the report indicates an identifier of the passive wireless device, a purpose for performing the signal strength measurement, or both.

In some examples, the signal strength measurement manager 1345 may be configured as or otherwise support a means for receiving, from a network node, a control message enabling the second wireless device to perform the signal strength measurement.

In some examples, the sensing manager 1360 may be configured as or otherwise support a means for detecting a sensing reference signal, where performing the signal strength measurement of the backscattered signal is based on the sensing reference signal.

In some examples, the measurement assistance manager 1360 may be configured as or otherwise support a means for receiving, via the backscatter link, a request for measurement assistance.

In some cases, the continuous wave signal manager 1325, the RF resource report manager 1330, the RF source manager 1335, the backscattered signal manager 1340, the signal strength measurement manager 1345, the signal strength report manager 1350, the sensing manager 1355, and the measurement assistance manager 1360 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the continuous wave signal manager 1325, the RF resource report manager 1330, the RF source manager 1335, the backscattered signal manager 1340, the signal strength measurement manager 1345, the signal strength report manager 1350, the sensing manager 1355, and the measurement assistance manager 1360 discussed herein.

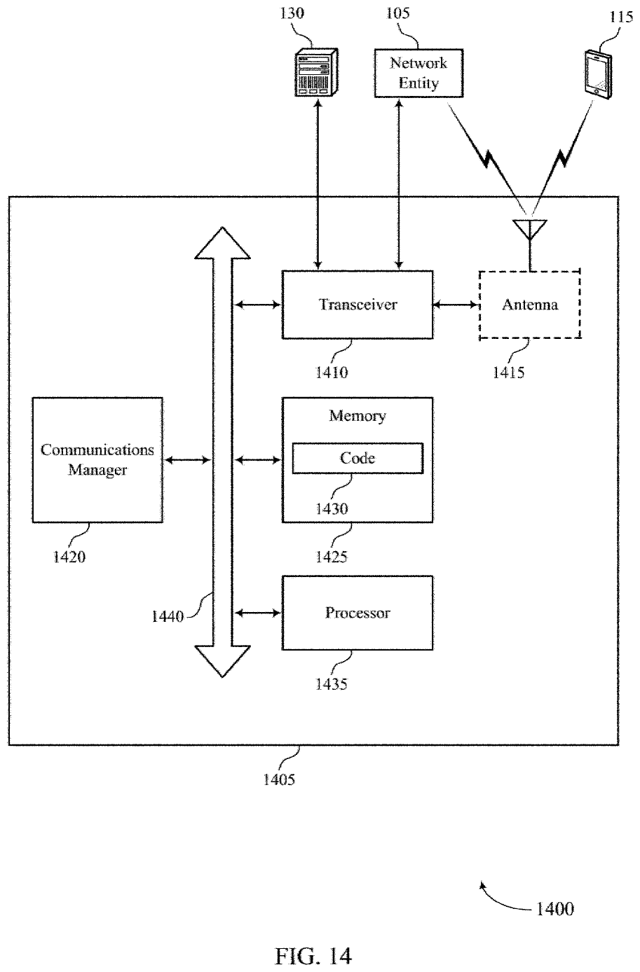

FIG. 14 illustrates a diagram of a system 1400 including a device 1405 that supports measurement relaxation and measurement assistance for passive wireless devices in accordance with one or more aspects of the present disclosure. The device 1405 may be an example of or include the components of a device 1105, a device 1205, or a wireless device as described herein. The device 1405 may include components for bi-directional voice and data communications including components for transmitting and receiving communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting measurement relaxation and measurement assistance for passive wireless devices). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a first wireless device in accordance with examples as disclosed herein. For example, the communications manager 1420 may be configured as or otherwise support a means for transmitting, to a passive wireless device, a continuous wave signal, the continuous wave signal triggering the passive wireless device to perform a measurement of a signal transmitted by the first wireless device or by a second wireless device in a RF resource. The communications manager 1420 may be configured as or otherwise support a means for receiving a report indicating the measurement of the signal in the RF resource. The communications manager 1420 may be configured as or otherwise support a means for transmitting a second continuous wave signal at an increased power level or a control message indicating that the passive wireless device is to switch to a different RF wireless device as a source for continuous wave signal transmissions based on the report.

Additionally, or alternatively, the communications manager 1420 may support wireless communication at a second wireless device in accordance with examples as disclosed herein. For example, the communications manager 1420 may be configured as or otherwise support a means for receiving, via a backscatter link, a backscattered signal indicating an inability of a passive wireless device to perform a RF resource measurement of a signal transmitted by a first wireless device. The communications manager 1420 may be configured as or otherwise support a means for performing a signal strength measurement of the backscattered signal. The communications manager 1420 may be configured as or otherwise support a means for transmitting, to the first wireless device, a report indicating the signal strength measurement of the backscattered signal.

By including or configuring the communications manager 1420 in accordance with examples as described herein, the device 1405 may support techniques for measurement reporting and assistance for passive wireless devices, which may reduce power consumption and reduce hardware, software, and firmware complexities.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of measurement relaxation and measurement assistance for passive wireless devices as described herein, or the processor 1435 and the memory 1425 may be otherwise configured to perform or support such operations.

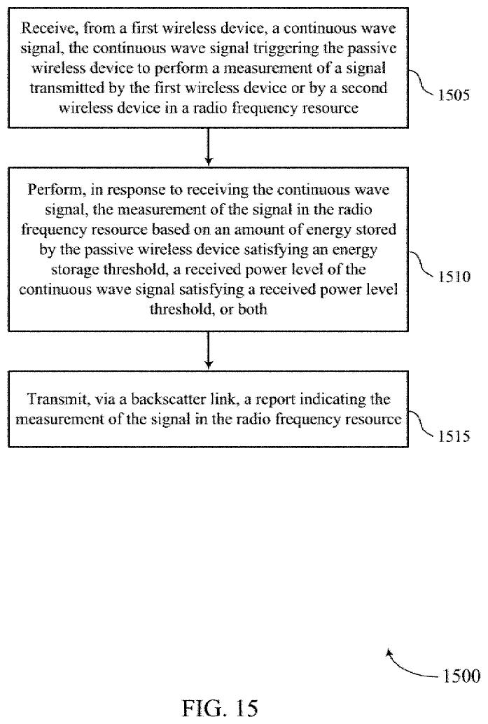

FIG. 15 illustrates a flowchart showing a method 1500 that supports measurement relaxation and measurement assistance for passive wireless devices in accordance with one or more aspects of the present disclosure. The operations of the method 1500 may be implemented by a passive wireless device or its components as described herein. For example, the operations of the method 1500 may be performed by a passive wireless device as described with reference to FIGS. 1 through 10. In some examples, a passive wireless device may execute a set of instructions to control the functional elements of the passive wireless device to perform the described functions. Additionally, or alternatively, the passive wireless device may perform aspects of the described functions using special-purpose hardware.

At 1505, the method may include receiving, from a first wireless device, a continuous wave signal, the continuous wave signal triggering the passive wireless device to perform a measurement of a signal transmitted by the first wireless device or by a second wireless device in a RF resource. The operations of 1505 may be performed in accordance with examples as disclosed herein. In some examples, aspects of the operations of 1505 may be performed by a continuous wave signal component 925 as described with reference to FIG. 9.

At 1510, the method may include performing, in response to receiving the continuous wave signal, the measurement of the signal in the RF resource based on an amount of energy stored by the passive wireless device satisfying an energy storage threshold, a received power level of the continuous wave signal satisfying a received power level threshold, or both. The operations of 1510 may be performed in accordance with examples as disclosed herein. In some examples, aspects of the operations of 1510 may be performed by a measurement component 930 as described with reference to FIG. 9.

At 1515, the method may include transmitting, via a backscatter link, a report indicating the measurement of the signal in the RF resource. The operations of 1515 may be performed in accordance with examples as disclosed herein. In some examples, aspects of the operations of 1515 may be performed by a report component 935 as described with reference to FIG. 9.

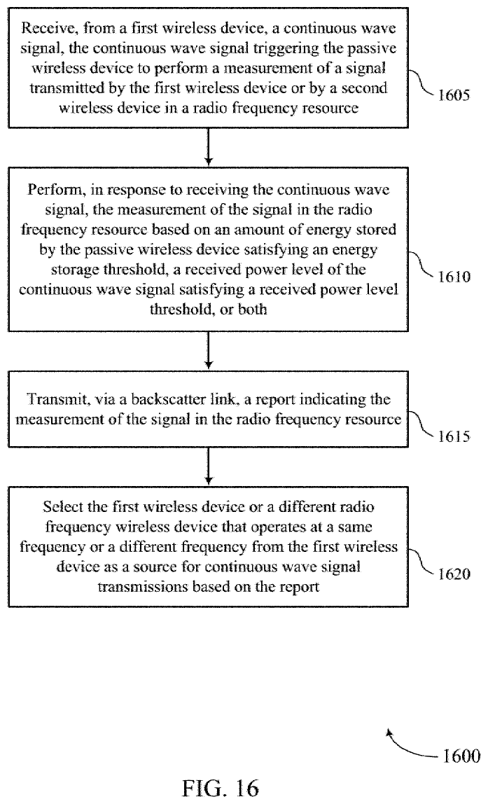

FIG. 16 illustrates a flowchart showing a method 1600 that supports measurement relaxation and measurement assistance for passive wireless devices in accordance with one or more aspects of the present disclosure. The operations of the method 1600 may be implemented by a passive wireless device or its components as described herein. For example, the operations of the method 1600 may be performed by a passive wireless device as described with reference to FIGS. 1 through 10. In some examples, a passive wireless device may execute a set of instructions to control the functional elements of the passive wireless device to perform the described functions. Additionally, or alternatively, the passive wireless device may perform aspects of the described functions using special-purpose hardware.

At 1605, the method may include receiving, from a first wireless device, a continuous wave signal, the continuous wave signal triggering the passive wireless device to perform a measurement of a signal transmitted by the first wireless device or by a second wireless device in a RF resource. The operations of 1605 may be performed in accordance with examples as disclosed herein. In some examples, aspects of the operations of 1605 may be performed by a continuous wave signal component 925 as described with reference to FIG. 9.

At 1610, the method may include performing, in response to receiving the continuous wave signal, the measurement of the signal in the RF resource based on an amount of energy stored by the passive wireless device satisfying an energy storage threshold, a received power level of the continuous wave signal satisfying a received power level threshold, or both. The operations of 1610 may be performed in accordance with examples as disclosed herein. In some examples, aspects of the operations of 1610 may be performed by a measurement component 930 as described with reference to FIG. 9.

At 1615, the method may include transmitting, via a backscatter link, a report indicating the measurement of the signal in the RF resource. The operations of 1615 may be performed in accordance with examples as disclosed herein. In some examples, aspects of the operations of 1615 may be performed by a report component 935 as described with reference to FIG. 9.

At 1620, the method may include selecting the first wireless device or a different RF wireless device that operates at a same frequency or a different frequency from the first wireless device as a source for continuous wave signal transmissions based on the report. The operations of 1620 may be performed in accordance with examples as disclosed herein. In some examples, aspects of the operations of 1620 may be performed by an RF source selection component 955 as described with reference to FIG. 9.

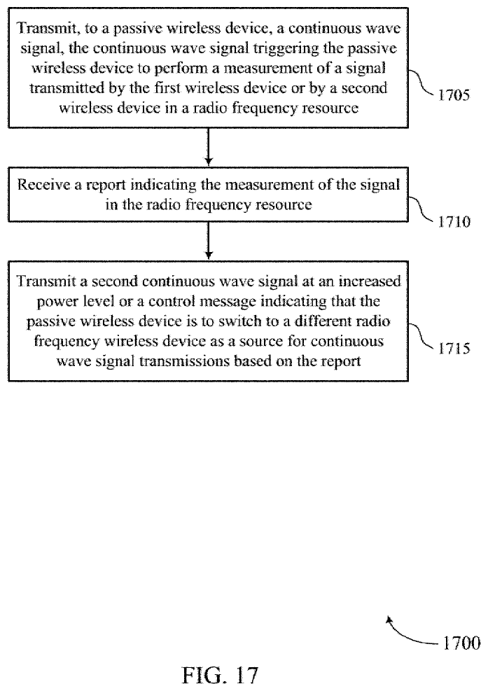

FIG. 17 illustrates a flowchart showing a method 1700 that supports measurement relaxation and measurement assistance for passive wireless devices in accordance with one or more aspects of the present disclosure. The operations of the method 1700 may be implemented by a wireless device or its components as described herein. For example, the operations of the method 1700 may be performed by a wireless device as described with reference to FIGS. 1 through 6 and 11 through 14. In some examples, a wireless device may execute a set of instructions to control the functional elements of the wireless device to perform the described functions. Additionally, or alternatively, the wireless device may perform aspects of the described functions using special-purpose hardware.

At 1705, the method may include transmitting, to a passive wireless device, a continuous wave signal, the continuous wave signal triggering the passive wireless device to perform a measurement of a signal transmitted by the first wireless device or by a second wireless device in a RF resource. The operations of 1705 may be performed in accordance with examples as disclosed herein. In some examples, aspects of the operations of 1705 may be performed by a continuous wave signal manager 1325 as described with reference to FIG. 13.

At 1710, the method may include receiving a report indicating the measurement of the signal in the RF resource. The operations of 1710 may be performed in accordance with examples as disclosed herein. In some examples, aspects of the operations of 1710 may be performed by an RF resource report manager 1330 as described with reference to FIG. 13.

At 1715, the method may include transmitting a second continuous wave signal at an increased power level or a control message indicating that the passive wireless device is to switch to a different RF wireless device as a source for continuous wave signal transmissions based on the report. The operations of 1715 may be performed in accordance with examples as disclosed herein. In some examples, aspects of the operations of 1715 may be performed by an RF source manager 1335 as described with reference to FIG. 13.

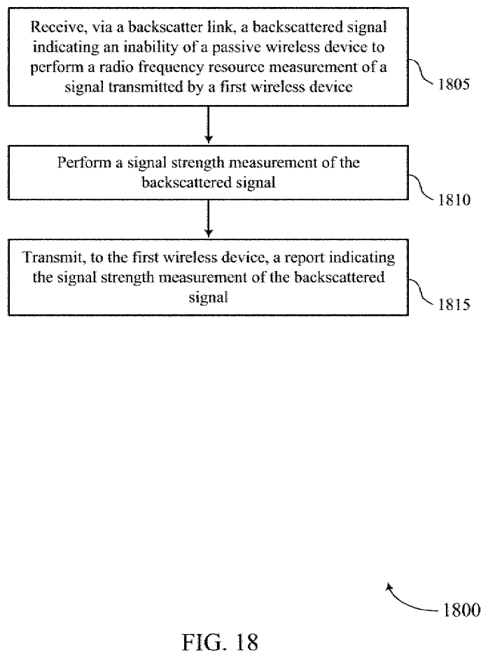

FIG. 18 illustrates a flowchart showing a method 1800 that supports measurement relaxation and measurement assistance for passive wireless devices in accordance with one or more aspects of the present disclosure. The operations of the method 1800 may be implemented by a wireless device or its components as described herein. For example, the operations of the method 1800 may be performed by a wireless device as described with reference to FIGS. 1 through 6 and 11 through 14. In some examples, a wireless device may execute a set of instructions to control the functional elements of the wireless device to perform the described functions. Additionally, or alternatively, the wireless device may perform aspects of the described functions using special-purpose hardware.

At 1805, the method may include receiving, via a backscatter link, a backscattered signal indicating an inability of a passive wireless device to perform a RF resource measurement of a signal transmitted by a first wireless device. The operations of 1805 may be performed in accordance with examples as disclosed herein. In some examples, aspects of the operations of 1805 may be performed by a backscattered signal manager 1340 as described with reference to FIG. 13.

At 1810, the method may include performing a signal strength measurement of the backscattered signal. The operations of 1810 may be performed in accordance with examples as disclosed herein. In some examples, aspects of the operations of 1810 may be performed by a signal strength measurement manager 1345 as described with reference to FIG. 13.

At 1815, the method may include transmitting, to the first wireless device, a report indicating the signal strength measurement of the backscattered signal. The operations of 1815 may be performed in accordance with examples as disclosed herein. In some examples, aspects of the operations of 1815 may be performed by a signal strength report manager 1350 as described with reference to FIG. 13.

The following provides an overview of aspects of the present disclosure:
Aspect 1: A method for wireless communication at a passive wireless device, comprising: receiving, from a first wireless device, a continuous wave signal, the continuous wave signal triggering the passive wireless device to perform a measurement of a signal transmitted by the first wireless device or by a second wireless device in a RF resource; performing, in response to receiving the continuous wave signal, the measurement of the signal in the RF resource based at least in part on an amount of energy stored by the passive wireless device satisfying an energy storage threshold, a received power level of the continuous wave signal satisfying a received power level threshold, or both; and transmitting, via a backscatter link, a report indicating the measurement of the signal in the RF resource.
Aspect 2: The method of aspect 1, further comprising: receiving, from the first wireless device or the second wireless device and via forward link, a control message triggering the passive wireless device to perform the measurement of the signal.
Aspect 3: The method of any of aspects 1 through 2, further comprising: transmitting a message indicating a preference of the passive wireless device to suspend the measurement of the signal based at least in the amount of energy stored by the passive wireless device and indicating a cause of suspending the measurement.
Aspect 4: The method of any of aspects 1 through 3, further comprising: skipping, in response to receiving the continuous wave signal, measurement of a second signal based at least in part the amount of energy stored by the passive wireless device failing to satisfy the energy storage threshold, the received power level of the continuous wave signal satisfying the received power level threshold, or both.
Aspect 5: The method of any of aspects 1 through 4, further comprising: detecting an increase in the amount of energy stored by the passive wireless device for a first time duration; and performing the measurement of the signal in the RF resource for a second time duration based at least in part on detecting the increase.
Aspect 6: The method of any of aspects 1 through 5, further comprising: detecting a decrease in the amount of energy stored by the passive wireless device for a first time duration; and suspending the measurement of the signal in the RF resource for a second time duration based at least in part on detecting the decrease.
Aspect 7: The method of any of aspects 1 through 6, further comprising: transmitting a capability message indicating a first capability of the passive wireless device to support detection of the amount of energy stored by the passive wireless device satisfying the energy storage threshold, the received power level of the continuous wave signal satisfying the received power level threshold, or both.
Aspect 8: The method of any of aspects 1 through 7, wherein performing the measurement of the signal comprises: performing a measurement of a plurality of signals in the RF resource, wherein the plurality of signals are transmitted by a plurality of RF source wireless devices including the first wireless device.
Aspect 9: The method of any of aspects 1 through 8, further comprising: receiving, from a network node, a control message indicating whether the passive wireless device is to perform the measurement of the signal transmitted by the first wireless device or a different RF wireless device, wherein the measurement comprises a one-shot measurement or a periodic measurement.
Aspect 10: The method of any of aspects 1 through 9, further comprising: receiving, via a forward link, a control message indicating one or more frequencies for which the passive wireless device is to perform the measurement.
Aspect 11: The method of any of aspects 1 through 10, further comprising: selecting the first wireless device or a different RF wireless device that operates at a same frequency or a different frequency from the first wireless device as a source for continuous wave signal transmissions based at least in part on the report.
Aspect 12: The method of any of aspects 1 through 11, further comprising: transmitting, via the backscatter link, a backscattered signal indicating an inability of the passive wireless device to perform a RF resource measurement of the signal transmitted by the first wireless device.
Aspect 13: The method of any of aspects 1 through 12, further comprising: transmitting, via the backscatter link, a request for measurement assistance.
Aspect 14: The method of any of aspects 1 through 13, wherein performing the measurement of the signal comprises: performing the measurement of the signal in the RF resource based at least in part on a distance between the passive wireless device and the first wireless device being shorter than a distance threshold.
Aspect 15: The method of any of aspects 1 through 14, further comprising: receiving, from the first wireless device, a sensing reference signal in a sensing resource; and performing a sensing measurement based at least in part on the sensing reference signal.
Aspect 16: A method for wireless communication at a first wireless device, comprising: transmitting, to a passive wireless device, a continuous wave signal, the continuous wave signal triggering the passive wireless device to perform a measurement of a signal transmitted by the first wireless device or by a second wireless device in a RF resource; receiving a report indicating the measurement of the signal in the RF resource; and transmitting a second continuous wave signal at an increased power level or a control message indicating that the passive wireless device is to switch to a different RF wireless device as a source for continuous wave signal transmissions based at least in part on the report.
Aspect 17: The method of aspect 16, further comprising: transmitting, to the second wireless device, a request for the second wireless device to transmit the control message indicating that the passive wireless device is to switch to the different RF wireless device as the source for the continuous wave signal transmissions based at least in part on the report.
Aspect 18: The method of any of aspects 16 through 17, further comprising: transmitting, to the passive wireless device, a sensing reference signal in a sensing resource, wherein the first wireless device is associated with a sensing capability.
Aspect 19: A method for wireless communication at a second wireless device, comprising: receiving, via a backscatter link, a backscattered signal indicating an inability of a passive wireless device to perform a RF resource measurement of a signal transmitted by a first wireless device; performing a signal strength measurement of the backscattered signal; and transmitting, to the first wireless device, a report indicating the signal strength measurement of the backscattered signal.
Aspect 20: The method of aspect 19, wherein the report indicates an identifier of the passive wireless device, a purpose for performing the signal strength measurement, or both.
Aspect 21: The method of any of aspects 19 through 20, further comprising: receiving, from a network node, a control message enabling the second wireless device to perform the signal strength measurement.
Aspect 22: The method of any of aspects 19 through 21, further comprising: detecting a sensing reference signal, wherein performing the signal strength measurement of the backscattered signal is based at least in part on the sensing reference signal.
Aspect 23: The method of any of aspects 19 through 22, further comprising: receiving, via the backscatter link, a request for measurement assistance.
Aspect 24: An apparatus for wireless communication at a passive wireless device, comprising a processor; memory coupled with the processor; and instructions stored in the memory and executable by the processor to cause the apparatus to perform a method of any of aspects 1 through 15.
Aspect 25: An apparatus for wireless communication at a passive wireless device, comprising at least one means for performing a method of any of aspects 1 through 15.
Aspect 26: A non-transitory computer-readable medium storing code for wireless communication at a passive wireless device, the code comprising instructions executable by a processor to perform a method of any of aspects 1 through 15.
Aspect 27: An apparatus for wireless communication at a first wireless device, comprising a processor; memory coupled with the processor; and instructions stored in the memory and executable by the processor to cause the apparatus to perform a method of any of aspects 16 through 18.
Aspect 28: An apparatus for wireless communication at a first wireless device, comprising at least one means for performing a method of any of aspects 16 through 18.
Aspect 29: A non-transitory computer-readable medium storing code for wireless communication at a first wireless device, the code comprising instructions executable by a processor to perform a method of any of aspects 16 through 18.
Aspect 30: An apparatus for wireless communication at a second wireless device, comprising a processor; memory coupled with the processor; and instructions stored in the memory and executable by the processor to cause the apparatus to perform a method of any of aspects 19 through 23.
Aspect 31: An apparatus for wireless communication at a second wireless device, comprising at least one means for performing a method of any of aspects 19 through 23.
Aspect 32: A non-transitory computer-readable medium storing code for wireless communication at a second wireless device, the code comprising instructions executable by a processor to perform a method of any of aspects 19 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a passive wireless device, comprising:
a processor;
memory coupled with the processor; and
instructions stored in the memory and executable by the processor to cause the apparatus to:
receive, from a first wireless device, a continuous wave signal, the continuous wave signal triggering the passive wireless device to perform a measurement of a signal transmitted by the first wireless device or by a second wireless device in a RF resource;
perform, in response to receiving the continuous wave signal, the measurement of the signal in the RF resource based at least in part on an amount of energy stored by the passive wireless device satisfying an energy storage threshold, a received power level of the continuous wave signal satisfying a received power level threshold, or both; and
transmit, via a backscatter link, a report indicating the measurement of the signal in the RF resource.

2. The apparatus of claim 1, wherein the instructions are further executable by the processor to:
receive, from the first wireless device or the second wireless device and via forward link, a control message triggering the passive wireless device to perform the measurement of the signal.

3. The apparatus of claim 1, wherein the instructions are further executable by the processor to:
transmit a message indicating a preference of the passive wireless device to suspend the measurement of the signal based at least in the amount of energy stored by the passive wireless device and indicating a cause of suspending the measurement.

4. The apparatus of claim 1, wherein the instructions are further executable by the processor to:
skip, in response to receiving the continuous wave signal, measurement of a second signal based at least in part on the amount of energy stored by the passive wireless device failing to satisfy the energy storage threshold, the received power level of the continuous wave signal satisfying the received power level threshold, or both.

5. The apparatus of claim 1, wherein the instructions are further executable by the processor to:
detect an increase in the amount of energy stored by the passive wireless device for a first time duration; and
perform the measurement of the signal in the RF resource for a second time duration based at least in part on detecting the increase.

6. The apparatus of claim 1, wherein the instructions are further executable by the processor to:
detect a decrease in the amount of energy stored by the passive wireless device for a first time duration; and
suspend the measurement of the signal in the RF resource for a second time duration based at least in part on detecting the decrease.

7. The apparatus of claim 1, wherein the instructions are further executable by the processor to:
transmit a capability message indicating a first capability of the passive wireless device to support detection of the amount of energy stored by the passive wireless device satisfying the energy storage threshold, the received power level of the continuous wave signal satisfying the received power level threshold, or both.

8. The apparatus of claim 1, wherein the instructions are further executable by the processor to perform the measurement of the signal by being executable by the processor to:
perform a measurement of a plurality of signals in the RF resource, wherein the plurality of signals are transmitted by a plurality of RF source wireless devices including the first wireless device.

9. The apparatus of claim 1, wherein the instructions are further executable by the processor to:
receive, from a network node, a control message indicating whether the passive wireless device is to perform the measurement of the signal transmitted by the first wireless device or a different RF wireless device, wherein the measurement comprises a one-shot measurement or a periodic measurement.

10. The apparatus of claim 1, wherein the instructions are further executable by the processor to:
receive, via a forward link, a control message indicating one or more frequencies for which the passive wireless device is to perform the measurement.

11. The apparatus of claim 1, wherein the instructions are further executable by the processor to:
select the first wireless device or a different RF wireless device that operates at a same frequency or a different frequency from the first wireless device as a source for continuous wave signal transmissions based at least in part on the report.

12. The apparatus of claim 1, wherein the instructions are further executable by the processor to:
transmit, via the backscatter link, a backscattered signal indicating an inability of the passive wireless device to perform a RF resource measurement of the signal transmitted by the first wireless device.

13. The apparatus of claim 1, wherein the instructions are further executable by the processor to:
transmit, via the backscatter link, a request for measurement assistance.

14. The apparatus of claim 1, wherein the instructions are further executable by the processor to perform the measurement of the signal by being executable by the processor to:
perform the measurement of the signal in the RF resource based at least in part on a distance between the passive wireless device and the first wireless device being shorter than a distance threshold.

15. The apparatus of claim 1, wherein the instructions are further executable by the processor to:
receive, from the first wireless device, a sensing reference signal in a sensing resource; and
perform a sensing measurement based at least in part on the sensing reference signal.

16. An apparatus for wireless communication at a first wireless device, comprising:
a processor;
memory coupled with the processor; and
instructions stored in the memory and executable by the processor to cause the apparatus to:
transmit, to a passive wireless device, a continuous wave signal, the continuous wave signal triggering the passive wireless device to perform a measurement of a signal transmitted by the first wireless device or by a second wireless device in a RF resource;
receive a report indicating the measurement of the signal in the RF resource; and
transmit a second continuous wave signal at an increased power level or a control message indicating that the passive wireless device is to switch to a different RF wireless device as a source for continuous wave signal transmissions based at least in part on the report.

17. The apparatus of claim 16, wherein the instructions are further executable by the processor to:
transmit, to the second wireless device, a request for the second wireless device to transmit the control message indicating that the passive wireless device is to switch to the different RF wireless device as the source for the continuous wave signal transmissions based at least in part on the report.

18. The apparatus of claim 16, wherein the instructions are further executable by the processor to:
transmit, to the passive wireless device, a sensing reference signal in a sensing resource, wherein the first wireless device is associated with a sensing capability.

19. An apparatus for wireless communication at a second wireless device, comprising:
a processor;
memory coupled with the processor; and
instructions stored in the memory and executable by the processor to cause the apparatus to:
receive, via a backscatter link, a backscattered signal indicating an inability of a passive wireless device to perform a RF resource measurement of a signal transmitted by a first wireless device;
perform a signal strength measurement of the backscattered signal; and
transmit, to the first wireless device, a report indicating the signal strength measurement of the backscattered signal.

20. The apparatus of claim 19, wherein the report indicates an identifier of the passive wireless device, a purpose for performing the signal strength measurement, or both;
wherein the instructions are further executable by the processor to:
receive, from a network node, a control message enabling the second wireless device to perform the signal strength measurement;
detect a sensing reference signal, wherein performing the signal strength measurement of the backscattered signal is based at least in part on the sensing reference signal; and
receive, via the backscatter link, a request for measurement assistance.

21-30. (canceled)
